(19) United States
(12) Patent Application Publication
(10) Pub. No.: US 2010/0232318 A1
(43) Pub. Date: Sep. 16, 2010

(54) RANDOM ACCESS CHANNEL (RACH) OPTIMIZATION FOR A SELF-ORGANIZING NETWORK (SON)

(75) Inventor: Sandip Sarkar, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/720,565

(22) Filed: Mar. 9, 2010

Related U.S. Application Data
(60) Provisional application No. 61/158,990, filed on Mar. 10, 2009.

(51) Int. Cl. H04L 12/28; H04L 12/26

(52) U.S. Cl. 370/254; 370/252

(57) ABSTRACT

Systems and methodologies are described that facilitate optimizing parameters for random access in a wireless communication environment. A network manager can select centrally optimized parameters for random access that mitigate interference among RACH attempts and/or mitigate uplink interference due to RACH in a SON. Moreover, a base station can select locally optimized parameters for random access that mitigate a number of access attempts, mitigate interference among RACH attempts, and/or mitigate uplink interference due to RACH. The centrally optimized parameters can include PRACH configurations, root sequence parameters, ranges for one or more MAC parameters (e.g., initial transmit power, power ramp step, maximum number of preamble transmissions, contention resolution timer, . . . ), and so forth. Further, the locally optimized parameters can include sequence length, one or more MAC parameters (e.g., initial received target power of the random access preamble, power ramp step, contention resolution timer, maximum number of preamble transmissions, . . . ), etc.

### CROSS-REFERENCE TO RELATED APPLICATIONS

This application claims the benefit of U.S. Provisional Patent Application Ser. No. 61/158,990 entitled “METHOD AND APPARATUS TO ENABLE RANDOM ACCESS CHANNEL (RACH) OPTIMIZATION FOR LTE SELF-ORGANIZING NETWORKS (SON)” which was filed Mar. 10, 2009. The entirety of the aforementioned application is herein incorporated by reference.

### BACKGROUND

I. Field

The following description relates generally to wireless communications, and more particularly to optimizing Random Access Channel (RACH) parameters for a self-organizing network (SON) in a wireless communication system.

II. Background

Wireless communication systems are widely deployed to provide various types of communication; for instance, voice and/or data can be provided via such wireless communication systems. A typical wireless communication system, or network, can provide multiple users access to one or more shared resources (e.g., bandwidth, transmit power, . . . ). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple-access communication systems can simultaneously support communication for multiple user equipments (UEs). Each UE can communicate with one or more base stations via transmissions on forward and reverse links. The forward link (or downlink) refers to the communication link from base stations to UEs, and the reverse link (or uplink) refers to the communication link from UEs to base stations. This communication link can be established via a single-in-single-out, a multiple-in-single-out or a multiple-in-multiple-out (MIMO) system.

MIMO systems commonly employ multiple (N_{T}) transmit antennas and multiple (N_{R}) receive antennas for data transmission. A MIMO channel formed by the N_{T} transmit and N_{R} receive antennas can be decomposed into N_{S} independent channels, which can be referred to as spatial channels, where N_{S}≦{N_{T},N_{R}}. Each of the N_{S} independent channels corresponds to a dimension. Moreover, MIMO systems can provide improved performance (e.g., increased spectral efficiency, higher throughput and/or greater reliability) if the additional dimensionalities created by the multiple transmit and receive antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region so that the reciprocity principle allows estimation of the forward link channel from the reverse link channel.

Wireless communication systems oftentimes employ one or more base stations that provide a coverage area. A typical base station can transmit multiple data streams for broadcast, multicast and/or unicast services, wherein a data stream may be a stream of data that can be of independent reception interest to a UE. A UE within the coverage area of such base station can be employed to receive one, more than one, or all the data streams carried by the composite stream. Likewise, a UE can transmit data to the base station or another UE.

Heterogeneous wireless communication systems commonly can include various types of base stations, each of which can be associated with differing cell sizes. For instance, macro cell base stations typically leverage antenna(s) installed on masts, rooftops, other existing structures, or the like. Further, macro cell base stations oftentimes have power outputs on the order of tens of watts, and can provide coverage for large areas. The femto cell base station is another class of base station that has recently emerged. Femto cell base stations are commonly designed for residential or small business environments, and can provide wireless coverage to UEs using a wireless technology (e.g., 3GPP Universal Mobile Telecommunications System (UMTS) or LTE, 1× Evolution-Data Optimized (1×EV-DO), . . . ) to communicate with the UEs and an existing broadband Internet connection (e.g., digital subscriber line (DSL), cable, . . . ) for backhaul. A femto cell base station can also be referred to as a Home Evolved Node B (HeNB), a Home Node B (HNB), a femto cell, an access point base station, or the like. Examples of other types of base stations include pico cell base stations, micro cell base stations, and so forth.

Conventionally, base stations being added to and/or removed from wireless communication networks can lead to network operators potentially redesigning such networks. Thus, network operators commonly can spend significant time and resources maintaining the wireless communication networks as base stations are included in and/or removed from such wireless communication networks. Yet, as femto cell base stations become more prevalent, network operators may be unaware of femto cell base stations added to the wireless communications networks (e.g., network operators can lack knowledge of locations of the added femto cell base stations, . . . ). Thus, parameters utilized (e.g., by base stations, UEs, . . . ) within the wireless communications networks in connection with random access can lead to access delays, interference, and the like.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating optimization of parameters for random access in a wireless communication environment. A network manager can select centrally optimized parameters for random access that mitigate interference among RACH attempts and/or mitigate uplink interference due to RACH in a SON. Moreover, a base station can select locally optimized parameters for random access that mitigate a number of access attempts, mitigate interference among RACH attempts, and/or mitigate uplink interference due to RACH. The centrally optimized parameters can include PRACH configurations, root sequence parameters, ranges for one or more MAC parameters (e.g., initial transmit power, power ramp step, maximum number of preamble transmissions, contention resolution timer, . . . ), and so forth. Further, the locally optimized parameters can include sequence length, one or more MAC parameters (e.g., initial received target power of the random access preamble, power ramp step, contention resolution timer, maximum number of preamble transmissions, . . . ), etc.

According to related aspects, a method that facilitates centrally optimizing parameters for random access in a wireless communication environment is described herein. The method can include selecting centrally optimized parameters for random access that at least one of mitigate interference among Random Access Channel (RACH) attempts or mitigate uplink interference due to a RACH in a self-organizing network (SON). Further, the method can include transmitting information that configures a set of base stations to use the centrally optimized parameters for random access as selected.

Another aspect relates to a wireless communications apparatus. The wireless communications apparatus can include a memory that that retains instructions related to selecting centrally optimized parameters for random access that at least one of mitigate interference among Random Access Channel (RACH) attempts or mitigate uplink interference due to a RACH in a self-organizing network (SON), and transmitting information that configures a set of base stations to use the centrally optimized parameters for random access as selected. Further, the wireless communications apparatus can include a processor, coupled to the memory, configured to execute the instructions retained in the memory.

Yet another aspect relates to a wireless communications apparatus that enables centrally optimizing parameters for random access in a wireless communication environment. The wireless communications apparatus can include means for selecting centrally optimized parameters for random access that at least one of mitigate interference among Random Access Channel (RACH) attempts or mitigate uplink interference due to RACH in a self-organizing network (SON). Further, the wireless communications apparatus can include means for transmitting information that configures a set of base stations to use the centrally optimized parameters for random access as selected.

Still another aspect relates to a computer program product that can comprise a computer-readable medium. The computer-readable medium can include code for selecting centrally optimized parameters for random access that at least one of mitigate interference among Random Access Channel (RACH) attempts or mitigate uplink interference due to RACH in a self-organizing network (SON). Moreover, the computer-readable medium can include code for transmitting information that configures a set of base stations to use the centrally optimized parameters for random access as selected.

In accordance with another aspect, a wireless communications apparatus can include a processor, wherein the processor can be configured to select centrally optimized parameters for random access that at least one of mitigate interference among Random Access Channel (RACH) attempts or mitigate uplink interference due to a RACH in a self-organizing network (SON). Further, the processor can be configured to transmit information that configures a set of base stations to use the centrally optimized parameters for random access as selected.

According to other aspects, a method that facilitates locally optimizing parameters for random access in a wireless communication environment is described herein. The method can include receiving a message in a self-organizing network (SON) at a base station, the message indicates centrally optimized parameters for random access for the base station. Moreover, the method can include selecting locally optimized parameters for random access that at least one of mitigate a number of access attempts, mitigate interference among access attempts, or mitigate uplink interference due to a Random Access Channel (RACH). Further, the method can include receiving a random access preamble from a user equipment (UE) sent using the centrally optimized parameters and the locally optimized parameters.

Another aspect relates to a wireless communications apparatus. The wireless communications apparatus can include a memory that retains instructions related to receiving a message in a self-organizing network (SON) at a base station, the message indicates centrally optimized parameters for random access for the base station, selecting locally optimized parameters for random access that at least one of mitigate a number of access attempts, mitigate interference among access attempts, or mitigate uplink interference due to a Random Access Channel (RACH), and receiving a random access preamble from a user equipment (UE) sent using the centrally optimized parameters and the locally optimized parameters. Further, the wireless communications apparatus can include a processor, coupled to the memory, configured to execute the instructions retained in the memory.

Yet another aspect relates to a wireless communications apparatus that enables effectuating local optimization of parameters for random access in a wireless communication environment. The wireless communications apparatus can include means for receiving a message in a self-organizing network (SON) at a base station, the message indicates centrally optimized parameters for random access for the base station. Moreover, the wireless communications apparatus can include means for selecting locally optimized parameters for random access that at least one of mitigate a number of access attempts, mitigate interference among access attempts, or mitigate uplink interference due to a Random Access Channel (RACH). Further, the wireless communications apparatus can include means for receiving a random access preamble from a user equipment (UE) sent using the centrally optimized parameters and the locally optimized parameters.

Still another aspect relates to a computer program product that can comprise a computer-readable medium. The computer-readable medium can include code for receiving a message in a self-organizing network (SON) at a base station, the message indicates centrally optimized parameters for random access for the base station. Further, the computer-readable medium can include code for selecting locally optimized parameters for random access that at least one of mitigate a number of access attempts, mitigate interference among access attempts, or mitigate uplink interference due to a Random Access Channel (RACH). Moreover, the computer-readable medium can include code for receiving a random access preamble from a user equipment (UE) sent using the centrally optimized parameters and the locally optimized parameters.

In accordance with another aspect, a wireless communications apparatus can include a processor, wherein the processor can be configured to receive a message in a self-organizing network (SON) at a base station, the message indicates centrally optimized parameters for random access for the base station. Moreover, the processor can be configured to select locally optimized parameters for random access that at least one of mitigate a number of access attempts, mitigate interference among access attempts, or mitigate uplink interference due to a Random Access Channel (RACH). The processor can also be configured to receive a random access preamble from a user equipment (UE) sent using the centrally optimized parameters and the locally optimized parameters.

In accordance with other aspects, a method that facilitates indicating access delay in a wireless communication environment is described herein. The method can include tracking a number of access attempts by a user equipment (UE). Further, the method can include generating a random access preamble that reports the number of access attempts by the UE. Moreover, the method can include transmitting the random access preamble to a base station using centrally optimized parameters and locally optimized parameters selected by the base station.

Another aspect relates to a wireless communications apparatus. The wireless communications apparatus can include a memory that retains instructions related to tracking a number of access attempts by a user equipment (UE), generating a random access preamble that reports the number of access attempts by the UE, and transmitting the random access preamble to a base station using centrally optimized parameters and locally optimized parameters selected by the base station. Further, the wireless communications apparatus can include a processor, coupled to the memory, configured to execute the instructions retained in the memory.

Yet another aspect relates to a wireless communications apparatus that enables accessing a base station in a wireless communication environment. The wireless communications apparatus can include means for tracking a number of access attempts by a user equipment (UE). Further, the wireless communications apparatus can include means for generating a random access preamble that reports the number of access attempts by the UE. Moreover, the wireless communications apparatus can include means for transmitting the random access preamble to a base station using centrally optimized parameters and locally optimized parameters selected by the base station.

Still another aspect relates to a computer program product that can comprise a computer-readable medium. The computer-readable medium can include code for tracking a number of access attempts by a user equipment (UE). Moreover, the computer-readable medium can include code for generating a random access preamble that reports the number of access attempts by the UE. Further, the computer-readable medium can include code for transmitting the random access preamble to a base station using centrally optimized parameters and locally optimized parameters selected by the base station.

In accordance with another aspect, a wireless communications apparatus can include a processor, wherein the processor can be configured to track a number of access attempts by a user equipment (UE). Moreover, the processor can be configured to generate a random access preamble that reports the number of access attempts by the UE. Further, the processor can be configured to transmit the random access preamble to a base station using centrally optimized parameters and locally optimized parameters selected by the base station.

Toward the accomplishment of the foregoing and related ends, the one or more embodiments comprise the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example system that optimizes parameters for random access in a wireless communication environment.

FIG. 3 is an illustration of an example diagram of a RACH SOF that can be implemented in a wireless communication environment.

FIG. 4 is an illustration of an example SON architecture for RACH optimization that includes SON logical functions.

FIG. 5 is an illustration of example diagram showing random access preamble power ramping.

FIG. 6 is an illustration of an example system that employs the optimized RACH parameters in a wireless communication environment.

FIG. 7 is an illustration of an example RACH frame structure that can be employed in a wireless communication environment.

FIG. 8 is an illustration of an example frequency spectrum according to various aspects.

FIG. 9 is an illustration of an example methodology that facilitates centrally optimizing parameters for random access in a wireless communication environment.

FIG. 10 is an illustration of an example methodology that facilitates locally optimizing parameters for random access in a wireless communication environment.

FIG. 11 is an illustration of an example methodology that facilitates indicating a number of access attempts in a wireless communication environment.

FIG. 12 is an illustration of an example UE that yields random access preambles in a wireless communication system.

FIG. 13 is an illustration of an example system that locally optimizes parameters for random access in a wireless communication environment.

FIG. 14 is an illustration of an example wireless network environment that can be employed in conjunction with the various systems and methods described herein.

FIG. 15 is an illustration of an example system that enables centrally optimizing parameters for random access in a wireless communication environment.

FIG. 16 is an illustration of an example system that enables effectuating local optimization of parameters for random access in a wireless communication environment.

FIG. 17 is an illustration of an example system that enables accessing a base station in a wireless communication environment.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits UEs in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with a user equipment (UE). A UE can also be called a system, subscriber unit, subscriber station, mobile station, mobile, remote station, remote terminal, mobile device, user terminal, terminal, wireless communication device, user agent, user device, or access terminal A UE can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with UE(s) and can also be referred to as an access point, Node B, Evolved Node B (eNodeB, eNB) or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

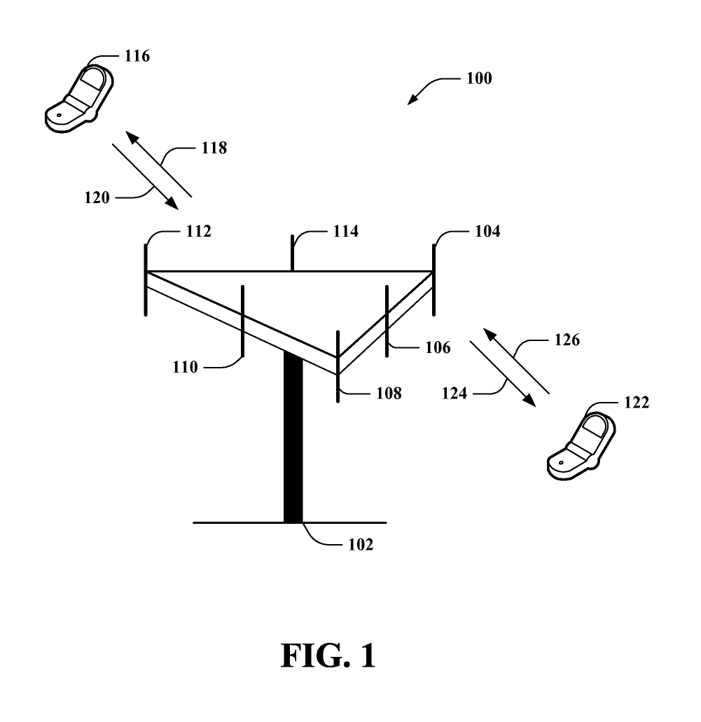

Referring now to FIG. 1, a system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more user equipments (UEs) such as UE 116 and UE 122; however, it is to be appreciated that base station 102 can communicate with substantially any number of UEs similar to UEs 116 and 122. UEs 116 and 122 can be, for example, cellular phones, smart phones, laptops, handheld communication devices, handheld computing devices, satellite radios, global positioning systems, PDAs, and/or any other suitable device for communicating over system 100. As depicted, UE 116 is in communication with antennas 112 and 114, where antennas 112 and 114 transmit information to UE 116 over a forward link 118 and receive information from UE 116 over a reverse link 120. Moreover, UE 122 is in communication with antennas 104 and 106, where antennas 104 and 106 transmit information to UE 122 over a forward link 124 and receive information from UE 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to UEs in a sector of the areas covered by base station 102. In communication over forward links 118 and 124, the transmitting antennas of base station 102 can utilize beamforming to improve signal-to-noise ratio of forward links 118 and 124 for UEs 116 and 122. Also, while base station 102 utilizes beamforming to transmit to UEs 116 and 122 scattered randomly through an associated coverage, UEs in neighboring cells can be subject to less interference as compared to a base station transmitting through a single antenna to all its UEs.

System 100 can be part of a self-organizing network (SON). By way of illustration, base station 102 can be added to the SON. When added to the SON, base station 102 can be configured in a plug-and-play fashion (e.g., self-configured, . . . ), while other base stations (not shown) existing in the SON can continuously self-optimize operational algorithms and parameters based upon factors such as changes in the network (e.g., addition of base station 102, addition or removal of a disparate base station (not shown), . . . ), traffic, conditions, and the like. Pursuant to another example, base station 102 can self-optimize operational algorithms and parameters upon a disparate base station (not shown) being added or removed from the SON. Further, it is contemplated that base station 102 can be any type of base station (e.g., femto cell base station, macro cell base station, micro cell base station, pico cell base station, relay base station, . . . ).

Further, a SON Optimization Function (SOF) can be implemented in system 100 to optimize parameters. For instance, the SOF can be utilized for Random Access Channel (RACH) parameter optimization to provide benefits to a deployed network. Accordingly, optimization of RACH parameters can enable minimizing unnecessary interference and/or reducing latency of successful RACH attempts (e.g., access attempts, . . . ). The SOF can be performed by base station 102 (and/or disparate base station(s) (not shown)), UE 116 and/or UE 122 (and/or disparate UE(s) (not shown)), one or more network nodes (e.g., a network manager, . . . ) (not shown), a combination thereof, and so forth.

Various parameters related to random access can be optimized by the SOF. For instance, the parameters can be classified as being parameters that impact a number of access attempts (e.g., number of access attempts effectuated by UE 116, UE 122, any disparate UE (not shown) attempting to access base station 102 and/or any disparate base station (not shown), . . . ), parameters that impact interference among RACH attempts, and parameters that impact uplink interference. By way of example, through optimization described herein, the parameters that impact the number of access attempts can be optimized to reduce the number of access attempts (e.g., mitigating access delays, . . . ), the parameters that impact interference among RACH attempts can be optimized to reduce interference among RACH attempts, and/or the parameters that impact uplink interference can be optimized to reduce uplink interference.

Base station 102 (and/or any disparate base station (not shown)) can yield measurements that can be leveraged in connection with optimizing the parameters related to random access. For example, base station 102 can detect a number of access attempts of UE 116 and/or UE 118. Following this example, UE 116 and/or UE 118 can track and report a respective number of access attempts performed thereby to base station 102 (e.g., the number of access attempts can be specified in a random access preamble sent by UE 116 or UE 118, . . . ). Moreover, base station 102 can measure uplink interference due to RACH, interference among RACH attempts, and so forth.

Further, information can be exchanged over various interfaces to support the SOF for optimizing the parameters related to random access. As described below, information can be exchanged over the Uu interface (e.g., over-the-air interface between base station 102 and UE 116, interface between base station 102 and UE 122, . . . ), the X2 interface (e.g., interface between base station 102 and a disparate base station (not shown), . . . ), the Itf-N interface (e.g., interface between a network manager (not shown) and a device manager (not shown), . . . ) and the Itf-S interface (e.g., interface between the device manager and base station 102, . . . ), and so forth. The information exchanged over the various interfaces can relate to measurements, parameters, and the like.

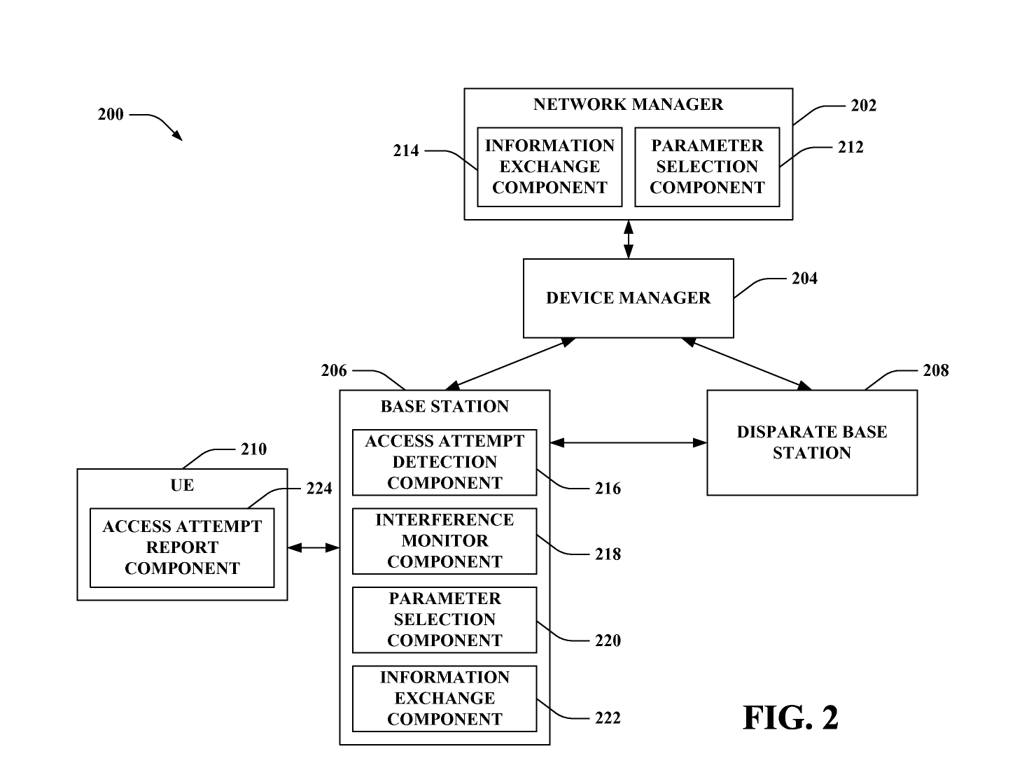

Now turning to FIG. 2, illustrated is a system 200 that optimizes parameters for random access in a wireless communication environment. System 200 includes a network manager 202, a device manager 204, a base station 206, a disparate base station 208, and a UE 210. Moreover, although not shown, it is contemplated that system 200 can include any number of differing network managers (e.g., similar to network manager 202, . . . ), any number of disparate device managers (e.g., similar to device manager 204, . . . ), any number of other base stations (e.g., similar to base station 206 and/or disparate base station 208, . . . ), and/or any number of differing UEs (e.g., similar to UE 210, . . . ).

Network manager 202 can utilize information related to base stations (e.g., base station 206, disparate base station 208, . . . ) and/or UEs (e.g., UE 210, . . . ) in system 200 to optimize network performance. For example, network manager 202 can centrally optimize parameters for random access. Network manager 202 can plan parameters for random access for a network (e.g., SON, system 200, . . . ), and can update the parameters for random access (e.g., as needed, periodically, . . . ). Network manager 202 can centrally optimize parameters for multiple vendors. It is to be appreciated that network manager 202 can be any appropriate network entity such as, for instance, a SON server, a Mobility Management Entity (MME), a network controller, a network management server, and so forth.

Information can be exchanged between network manager 202 and device manager 204 via an Itf-N interface. Further, device manager 204 can control one or more base stations, and can be vendor-specific. As depicted, device manager 204 can control base station 206 and disparate base station 208; yet, it is contemplated that the claimed subject matter is not so limited. Information can be exchanged between device manager 204 and base station 206 (and/or between device manager 204 and disparate base station 208) via an Itf-S interface.

Base station 206 (and similarly disparate base station 208) can transmit and/or receive information, signals, data, instructions, commands, bits, symbols, and the like. Base station 206 can communicate with UE 210 via the forward link and/or reverse link (e.g., over a Uu interface, . . . ). UE 210 can transmit and/or receive information, signals, data, instructions, commands, bits, symbols, and the like. Moreover, although not shown, it is contemplated that base station 206 can similarly communicate with any number of disparate UEs, which can be similar to UE 210. Further, base station 206 and disparate base station 208 can exchange information over an X2 interface.

UE 210 and base station 206 can exchange messages as part of a random access procedure. Parameters employed in connection with such random access procedure can be optimized in system 200. For instance, many of the examples set forth herein relate to contention based access, as contention free access optimization can be similar to network scheduling and budgeting for data traffic; however, the claimed subject matter is not so limited.

To enable optimizing parameters related to random access, network manager 202 can include a parameter selection component 212. Parameter selection component 212 can plan access parameters for the network (e.g., SON, system 200, . . . ). Further, parameter selection component 212 can update the access parameters (e.g., as needed, periodically, . . . ). When choosing the access parameters, parameter selection component 212 can optimize parameters to reduce interference among RACH attempts. Additionally or alternatively, when choosing the access parameters, parameter selection component 212 can optimize parameters to reduce uplink interference.

Parameter selection component 212 can minimize interference among RACH attempts by centrally configuring physical layer parameters, for example. Following this example, parameter selection component 212 can configure neighboring cells (e.g., associated with base station 206 and disparate base station 208, . . . ) to mitigate overlaps in sequence and/or frequency. Thus, parameter selection component 212 can select Physical Random Access Channel (PRACH) configurations and/or root sequence parameters (e.g., index, cyclic shift, set type, . . . ) to be utilized for attempting to access base station 206 and disparate base station 208 (and/or any other base station(s) (not shown)). Further, the physical layer parameters set by parameter selection component 212 can be call parameters that account for velocity of a UE (e.g., velocity of UE 210, . . . ). For instance, parameter selection component 212 can set a root sequence for high speed cells. By way of example, velocity of a UE being greater than or equal to 300 kph can be identified as high speed, while velocity of a UE being less than 300 kph can be identified as normal; yet, it is to be appreciated that the claimed subject matter is not so limited as it is contemplated that other thresholds are intended to fall within the scope of the hereto appended claims (e.g., 350 kph, substantially any other velocity, . . . ).

Pursuant to another example, parameter selection component 212 can minimize uplink interference due to RACH. Following this example, parameter selection component 212 can set a frequency band for RACH. Additionally or alternatively, parameter selection component 212 can set system information block (SIB) parameters to avoid overloading femto cell base station(s), pico cell base station(s), and the like. For instance, medium access control (MAC) parameters such as initial transmit power to be utilized for a random access preamble can be chosen by parameter selection component 212 to avoid overloading femto cell base station(s), pico cell base station(s), and the like. By way of example, parameter selection component 212 can assign the initial transmit power to be employed by UE 210 when sending a random access preamble (e.g., when attempting to access base station 206, . . . ).

Moreover, network manager 202 can include an information exchange component 214. Information exchange component 214 can send information related to parameters chosen by parameter selection component 212 over the Itf-N interface to device manager 204. Such information can be routed to respective intended base station(s) (e.g., base station 206, disparate base station 208, . . . ). Moreover, information exchange component 214 can receive information from one or more base stations (e.g., base station 206, disparate base station 208, . . . ) via device manager 204 (and/or from other base station(s) (not shown) via other device manager(s) (not shown)). The information received by information exchange component 214 can relate to parameters selected by the one or more base stations (e.g., locally optimized parameters, . . . ), measurements yielded by the one or more base stations, and so forth.

Further, base station 206 can include an access attempt detection component 216, an interference monitor component 218, a parameter selection component 220, and/or an information exchange component 222. Access attempt detection component 216 can detect a number of access attempts. For instance, access attempt detection component 216 can recognize a number of access attempts effectuated by UE 210. By way of example, UE 210 can further include an access attempt report component 224 that can report the number of access attempts made by UE 210 to base station 206. Following this example, access attempt detection component 216 can identify the number of access attempts reported by access attempt report component 224.

Moreover, interference monitor component 218 can measure interference at base station 206. For instance, interference monitor component 218 can measure uplink interference due to RACH. Additionally or alternatively, interference monitor component 218 can measure interference among RACH attempts.

Parameter selection component 220 can select parameters related to random access. For instance, parameter selection component 220 can locally optimize such parameters. Further, parameter selection component 220 can select the parameters based at least in part upon a measurement yielded by interference monitor component 218 and/or based upon a number of access attempts identified by access attempt detection component 216. By way of example, when choosing the parameters, parameter selection component 220 can optimize the parameters to reduce a number of access attempts. Further, when selecting the parameters, parameter selection component 220 can optimize the parameters to reduce interference among RACH attempts. Moreover, when choosing the parameters, parameter selection component 220 can optimize the parameters to reduce uplink interference.

Further, information exchange component 222 can send information to and/or receive information from network manager 202 (e.g., via device manager 204, over the Itf-S interface, . . . ). For example, the information received by information exchange component 222 from network manager 202 can pertain to parameters chosen by parameter selection component 212 as part of the aforementioned central optimization. By way of yet another example, information exchange component 222 can send information related to interference measurements (e.g., yielded by interference monitor component 218, . . . ), the number of access attempts (e.g., identified by access attempt detection component 216, . . . ), locally optimized parameters (e.g., chosen by parameter selection component 220, . . . ), and so forth to network manager 202.

Additionally or alternatively, information exchange component 222 can send and/or receive information over the X2 interface. Thus, information exchange component 222 can enable base station 206 and disparate base station 208 to exchange information there between. For example, information exchange component 222 can enable base station 206 to share information with disparate base station 208 over the X2 interface, thereby allowing for distributed optimization. According to an illustration, SIB information can be shared between neighboring base stations (e.g., between base station 206 and disparate base station 208, . . . ). By way of another illustration, a signaling message can be transferred over the X2 interface by information exchange component 222 that reports the number of access attempts (e.g., determined by access attempt detection component 216, . . . ). It is to be appreciated, however, that the claimed subject matter is not limited to the foregoing illustrations.

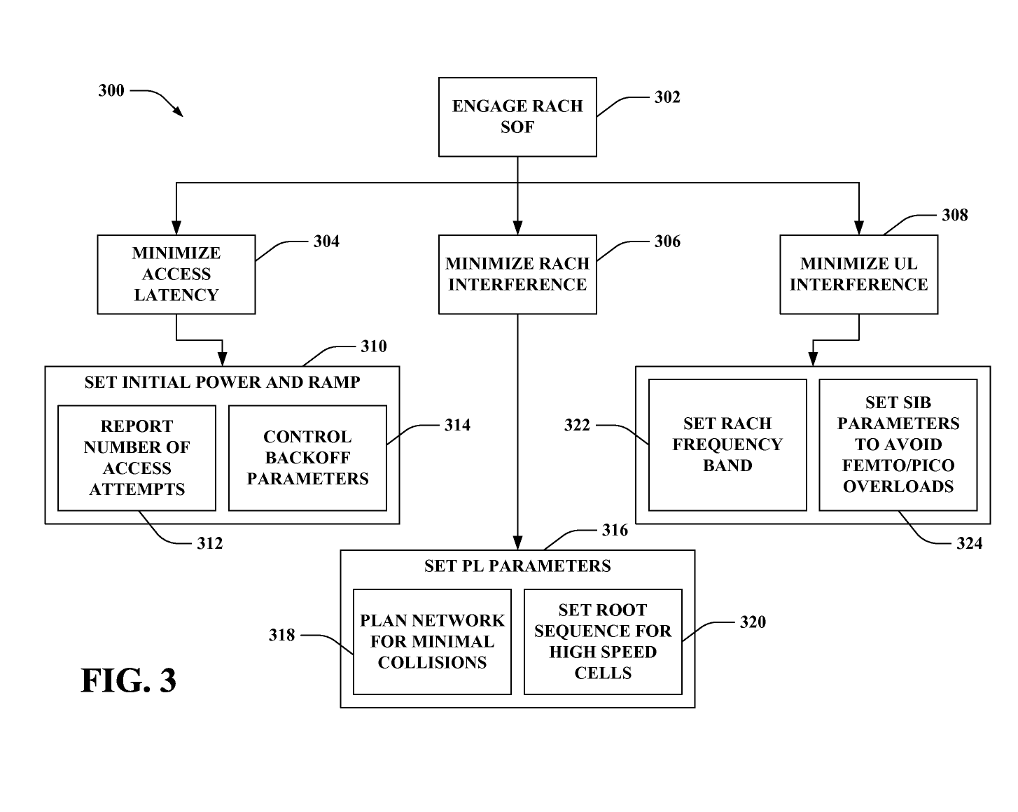

Now referring to FIG. 3, illustrated is an example diagram 300 of a RACH SOF that can be implemented in a wireless communication environment. At 302, a RACH SOF can be engaged. The RACH SOF can be effectuated to optimize various RACH parameters. When engaged at 302, the RACH SOF can minimize access latency at 304, minimize RACH interference at 306, and minimize uplink interference at 308.

Minimization of access latency at 304 can be controlled by setting initial power and ramp (e.g., power ramp step, step size, . . . ) for a random access preamble at 310. The initial power and ramp for the random access preamble can be optimized to allow for the random access preamble sent by a UE (e.g., UE 210 of FIG. 2, . . . ) to have sufficient power for a base station (e.g., base station 206 of FIG. 2, . . . ) to detect. The initial power for a random access preamble selected as part of the RACH SOF can be an initial received target power of the random access preamble (e.g., preamble initial received target power, . . . ) obtained at the base station. Further, the ramp can be a power ramp step (e.g., step size, . . . ), which can be a differential increase in received target power of the random access preamble for a subsequent transmission of the random access preamble (e.g., for a subsequent access attempt, . . . ) obtained at the base station. Setting of the initial power and ramp can leverage reporting a number of access attempts at 312 and/or controlling backoff parameters 314. For instance, the initial power and ramp can be selected based upon a reported number of access attempts supplied by a UE (e.g., provided by access attempt report component 224 of UE 210 of FIG. 2, . . . ). Further, the backoff parameters can be controlled to randomize timing of subsequent access attempts.

Minimization of RACH interference at 306 (e.g., minimizing interference among RACH attempts, . . . ) can be managed by setting physical layer parameters at 316. A network can be planned for minimal collisions at 318, which can mitigate RACH interference. Thus, neighboring cells (e.g., base station 206 and disparate base station 208, . . . ) can be configured to mitigate overlaps in sequence and/or frequency. Moreover, a root sequence for high speed cells can be set at 320 to mitigate RACH interference. Hence, call parameters can be chosen to account for velocity of a UE (e.g., UE 210 of FIG. 2, . . . ). By way of example, velocity of a UE being greater than or equal to 300 kph can be identified as high speed, while velocity of a UE being less than 300 kph can be identified as normal; yet, it is to be appreciated that the claimed subject matter is not so limited.

Minimization of uplink interference at 308 (e.g., uplink interference due to RACH, . . . ) can be controlled by setting a RACH frequency band at 322 and/or setting SIB parameters to avoid overloading femto cell base station(s), pico cell base station(s), and the like at 324. For instance, a tradeoff between latency and interference can exist. While an increase in the initial power and/or ramp can mitigate access latency, such increase can yield uplink interference due to RACH. Thus, if a power level of a random access preamble is too high, unnecessary uplink interference to other base station(s) caused thereby can result (e.g., a high power level utilized by UE 210 of FIG. 2 for sending a random access preamble to base station 206 of FIG. 2 can result in increased uplink interference to disparate base station 208 of FIG. 2, . . . ). Moreover, feedback can be utilized to improve performance of the foregoing; yet, the claimed subject matter is not so limited.

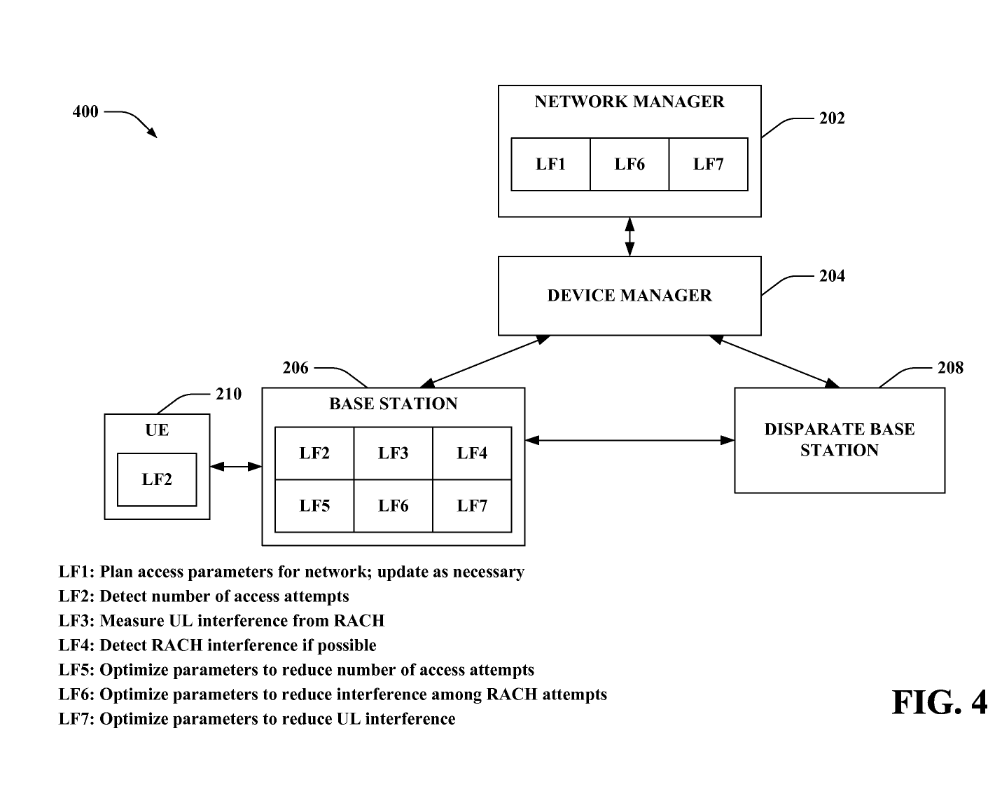

Now turning to FIG. 4, illustrated is an example SON architecture 400 for RACH optimization that includes SON logical functions. SON architecture 400 includes network manager 202, device manager 204, base station 206, disparate base station 208, and UE 210. However, it is to be appreciated that any number of disparate network managers, device managers, base stations, and/or UEs can be included in SON architecture 400. SON architecture 400 depicts locations at which the SON logical functions can be effectuated.

Network manager 202 can perform various SON logical functions. For example, network manager 202 can plan access parameters for a network (logical function 1 (LF1)). Moreover, as part of LF1, network manager 202 can update the access parameters for the network as necessary. According to another example, network manager 202 can optimize parameters to reduce interference among RACH attempts (logical function 6 (LF6)). By way of yet another example, network manager 202 can optimize parameters to reduce uplink interference (logical function 7 (LF7)).

Further, base station 206 can perform various SON logical functions. Pursuant to an example, base station 206 can detect a number of access attempts (logical function 2 (LF2)) (e.g., number of access attempts of UE 210, . . . ). In accordance with another example, base station 206 can measure uplink interference from RACH (logical function 3 (LF3)). Pursuant to another example, base station 206 can detect RACH interference if possible (logical function 4 (LF4)). According to yet another example, base station 206 can optimize parameters to reduce a number of access attempts (logical function 5 (LF5)). By way of a further example, base station 206 can optimize parameters to reduce interference among RACH attempts (LF6). According to another example, base station 206 can optimize parameters to reduce uplink interference (LF7).

Pursuant to an example, network manager 202 can centrally optimize parameters to reduce interference among RACH attempts (LF6) and/or centrally optimize parameters to reduce uplink interference (LF7). Moreover, base station 206 can further locally optimize parameters to reduce interference among RACH attempts (LF6) and/or locally optimize parameters to reduce uplink interference (LF7).

Moreover, UE 210 can perform a SON logical function. More particularly, UE 210 can detect a number of access attempts (LF2). For instance, the number of access attempts can be reported (e.g., to base station 206 to allow for detection by base station 206, . . . ).

Example SON architecture 400 depicts seven SON logical functions. It is to be appreciated, however, that a subset of the seven SON logical functions can be implemented, disparate SON logical function(s) (not shown) can be effectuated in addition to and/or in place of one or more of the seven SON logical functions, and so forth.

Again, reference is made to FIG. 2. When base station 206 is optimizing parameters to reduce a number of access attempts, parameter selection component 220 can control parameters related to random access preamble powers (e.g., utilized by UE(s) such as UE 210 attempting to access base station 206, . . . ). More particularly, parameter selection component 220 can control initial received target power of the random access preamble (e.g., preamble initial received target power, . . . ) and power ramp step. Additionally, parameter selection component 220 can control a contention resolution timer, which can be set to randomize subsequent access attempts. Further, parameter selection component 220 can control a maximum number of preamble transmissions (e.g., preamble transmission maximum, . . . ). Parameter selection component 220 can locally optimize these parameters at base station 206 based upon received RACH history information (e.g., collected by access attempt detection component 216, . . . ), for instance.

According to an example, access attempt report component 224 can report the number of access attempts by UE 210 in a radio resource control (RRC) message. Following this example, the number of access attempts by UE 210 can be specified in a random access preamble sent by UE 210. Thus, access attempt detection component 216 can recognize the number of access attempts as specified in a received random access preamble from UE 210 (e.g., upon a successful RACH attempt, . . . ).

While reporting the number of access attempts by UE 210 in the random access preamble can be used for successful RACH attempts, it is also contemplated that a SON report can be yielded by access attempt report component 224 to report the number of access attempts for both successful and unsuccessful access attempts from UE 210 to a SON server. Further, access attempt report component 224 can report transmit power of the random access preambles for both successful and unsuccessful access attempts. Information exchange component 222 can obtain information related to the number of successful and unsuccessful access attempts from the SON server. Additionally, information exchange component 222 can receive information related to the reported transmit power of the random access preambles. Such information collected by information exchange component 222 can be employed by parameter selection component 220 to locally optimize parameters to reduce the number of access attempts.

Moreover, parameter selection component 212 can control physical layer parameters to minimize interference among RACH attempts. For example, parameter selection component 212 can choose PRACH configurations to be utilized for attempting to access base station 206 and disparate base station 208 (and/or any other base station(s)). Following this example, parameter selection component 212 can optimize PRACH configuration indices across neighbors (e.g., base station 206 and disparate base station 208, . . . ) to minimize reuse of the same slots in neighboring cells (e.g., associated with base station 206 and disparate base station 208, . . . ). By way of illustration, parameter selection component 212 can assign a first PRACH configuration index for base station 206 and a second PRACH configuration index for disparate base station 208. As part of achieving this optimization, base station 206 (e.g., via information exchange component 222, . . . ) can share this SIB information with neighbor(s) (e.g., disparate base station 208, . . . ) over the X2 interface. According to a further example, PRACH configuration indices can be selected via distributed optimization (e.g., performed by parameter selection component 220 utilizing the SIB information exchanged over the X2 interface with information exchange component 222, . . . ).

A PRACH configuration index can map to a preamble format and a PRACH configuration. According to an illustration, 64 PRACH configurations can be supported in system 200, where PRACH configuration indices can range from 0 to 63. For instance, indices 30, 46, 60-62 can be unused; yet, the claimed subject matter is not so limited. Moreover, the 64 PRACH configurations can be divided into 4 groups of 16 PRACH configurations per preamble format (e.g., 0-15 for preamble format 0, 16-31 for preamble format 1, 32-47 for preamble format 2, and 48-63 for preamble format 3, . . . ). PRACH configuration can be chosen (e.g., optimized centrally, optimized in a distributed manner, . . . ) considering an amount of spectrum bandwidth/loading, and system information broadcast to UEs.

According to another example, parameter selection component 212 can choose root sequence parameters to minimize interference among RACH attempts. The root sequence parameters can include root sequence index (e.g., index to a root sequence table, . . . ), cyclic shift, sequence length (N_{CS}), set type (e.g., restricted, unrestricted, . . . ), and so forth. By being selected utilizing parameter selection component 212 of network manager 202, the root sequence parameters can be centrally planned.

In accordance with an illustration, the root sequence parameter selected by parameter selection component 212 can be root sequence indices, which can be centrally planned. Central planning (e.g., central optimization, . . . ) of the root sequence indices by parameter selection component 212, particularly for restricted cells, can enable optimizing reuse and (possibly) reserving a few root sequence indices (from the set of root sequence indices) for interference estimation. The term restricted can refer to a cell whose access sequence is chosen from a restricted set of sequences. Specifically, the cell can have a high speed flag set to true (e.g., identified as being high speed, . . . ). For example, a cell that is configured to support very high speed UEs can limit its access sequences to the restricted set. The centrally planned root sequences can be specified by Operations and Management (OAM). Further, the reserved root sequence indices can be used (e.g., by interference monitor component 218, . . . ) to measure interference caused in a RACH region (e.g., RACH area, frequency utilized for RACH, . . . ) at a base station (e.g., base station 206, . . . ). The measured interference can be relayed back to the OAM (e.g., employing information exchange component 222, . . . ) for further optimization (e.g., by parameter selection component 212, . . . ). Moreover, for unrestricted cells, information can be shared between base stations (e.g., base station 206 can employ information exchange component 222, . . . ) that can assist in choosing appropriate sequences (e.g., effectuated by parameter selection component 220, . . . ) in an exchange over the X2 interface.

In general, each base station can choose a sequence length, N_{CS}, per cell (e.g., parameter selection component 220 can select a sequence length, N_{CS}, for base station 206, the sequence length can be locally optimized, . . . ) according to expected round trip delay. Further, neighbor base stations can use different root sequences (e.g., base station 206 and disparate base station 208 can employ differing root sequences, . . . ) since the average cross correlation is (√839)⁻¹. For example, parameter selection component 212 can choose a root sequence to be leveraged by base station 206 and a differing root sequence to be employed by disparate base station 208. Following this example, information exchange component 214 can send a message instructing base station 206 and disparate base station 208 to utilize the respective root sequence corresponding thereto chosen by parameter selection component 212. Moreover, information exchange component 214 can transmit a message that causes a root sequence utilized by a base station (e.g., base station 206, disparate base station 208, . . . ) to be adjusted.

Within each cell, UEs can share the same root sequence, yet can use different cyclic shifts. For a large cell size, a second (or more) root sequence can be used (e.g., as controlled by parameter selection component 212, . . . ). For restricted cells (e.g.., for high speed mobility, . . . ), given a sequence length, N_{CS}, some roots can generate more non-overlapping cyclic shifts than others, but the set can be smaller. Accordingly, cell planning can provide nice reuse of the root sequences. Note that through centralized planning (e.g., effectuated by parameter selection component 212, . . . ), some root sequences can be reserved for interference estimation as described above. In contrast, without leveraging planning, neighbor cells may use the same root sequences leading to larger inter-cell interference.

Moreover, other physical layer parameters can be base station-specific. For instance, frequency position of the RACH and preamble format can be specific to a respective base station.

By way of another example, MAC parameters can be optimized to minimize uplink interference due to RACH. For instance, parameter selection component 212 of network manager 202 (e.g., OAM, . . . ) can specify respective ranges for the MAC parameters. Base stations can thereafter configure the MAC parameters. According to an illustration, parameter selection component 220 can set the MAC parameters within the designated ranges to be utilized in connection with attempting to access base station 206 (e.g., based upon OAM input regarding performance targets, . . . ); thus, base station 206 can locally optimize the MAC parameters within the designated ranges.

Examples of the MAC parameters that can be optimized (e.g., centrally and/or locally, . . . ) include initial received target power of the random access preamble (e.g., preamble initial received target power, . . . ), power ramp step, maximum number of preamble transmissions (e.g., preamble transmission maximum, . . . ), contention resolution timer, and so forth.

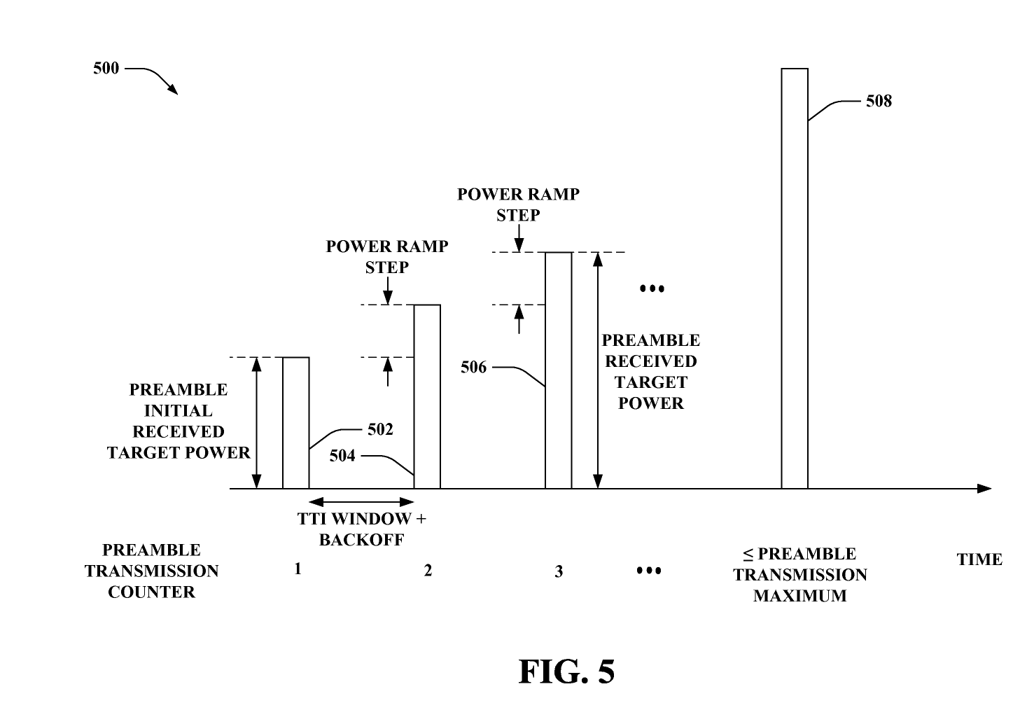

With reference to FIG. 5, illustrated is an example diagram 500 showing random access preamble power ramping. Diagram 500 includes a random access preamble 502 (e.g., associated with preamble transmission counter 1, . . . ), which can be transmitted at an initial power level (e.g., preamble initial received target power, . . . ). If access is unsuccessful, then the power level can subsequently ramp up. Thus, a next random access preamble 504 (e.g., associated with preamble transmission counter value 2, . . . ) can be transmitted at a power increased by a power ramp step (e.g., delta, . . . ) compared to random access preamble 502. Further, as shown, a third random access preamble 506 (e.g., associated with preamble transmission counter value 3, . . . ) can be transmitted at a power level increased by the power ramp step as compared to the previous random access preamble (e.g., random access preamble 504, . . . ). Hence, a base station (e.g., base station 206 of FIG. 2, . . . ) can obtain random access preamble 506 sent by a UE (e.g., UE 210 of FIG. 2, . . . ), where random access preamble 506 can have a preamble received target power being equal to the preamble initial received target power plus the power ramp step plus the power ramp step (e.g., preamble initial received target power+(2* power ramp step), . . . ). Moreover, a maximum number of random access preambles can be sent, as set forth by a preamble transmission maximum (e.g., a maximum preamble transmission counter value, . . . ). Thus, while access is unsuccessful, random access preambles can successively be transmitted at power levels that increase by the power ramp step until the maximum number (e.g., preamble transmission maximum, . . . ) of preamble transmissions is reached (e.g., as shown by random access preamble 508, . . . ). It is to be appreciated, however, that the maximum number of random access preambles need not be transmitted upon successful access (e.g., if a UE successfully accesses a base station after sending random access preamble 504, then the subsequent random access preamble(s) need not be sent, . . . ).

The parameters (e.g., MAC parameters, . . . ) guiding these access attempts can be specified as set forth above. Thus, OAM can configure ranges of the MAC parameters (e.g., centrally optimized, . . . ), while a base station can locally perform optimization of the MAC parameters within the ranges.

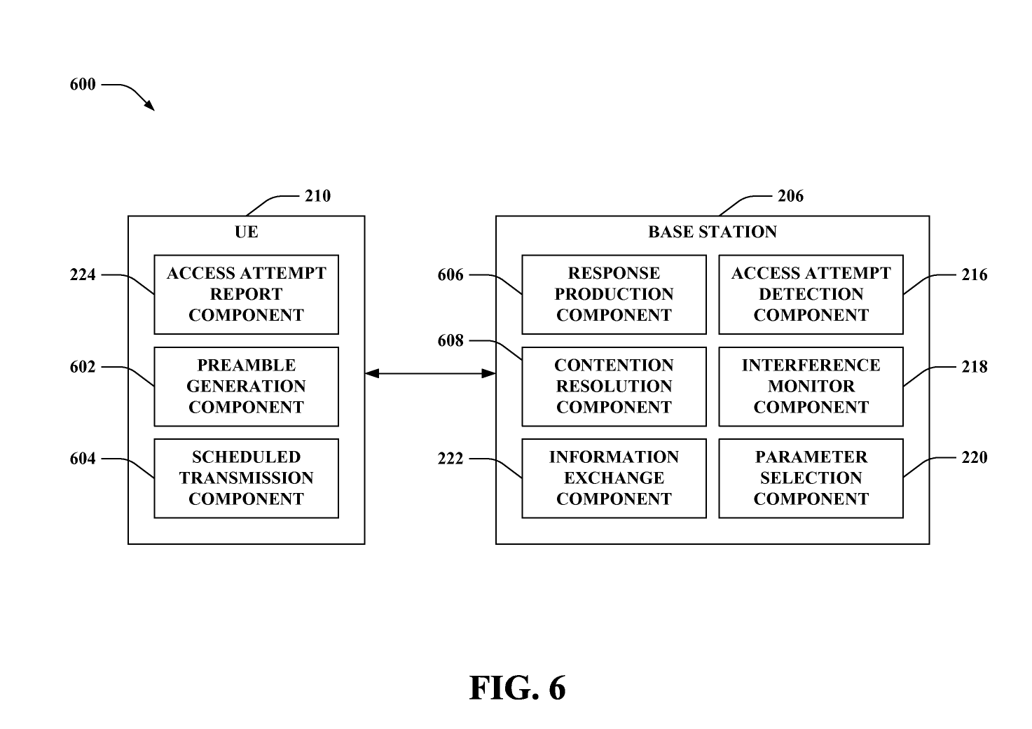

With reference to FIG. 6, illustrated is a system 600 that employs the optimized RACH parameters in a wireless communication environment. System 600 includes base station 206 and UE 210. Base station 206 can further include access attempt detection component 216, interference monitor component 218, parameter selection component 220, and/or information exchange component 222. Moreover, UE 210 can further include access attempt report component 224.

UE 210 and base station 206 can exchange messages as part of a random access procedure. To effectuate the random access procedure, UE 210 can include a preamble generation component 602 and a scheduled transmission component 604. Moreover, base station 206 can include a response production component 606 and a contention resolution component 608.

Preamble generation component 602 can yield a random access preamble (e.g., message 1, . . . ) that can be sent by UE 210 over an uplink to base station 206. Preamble generation component 602 can yield the random access preamble using optimized RACH parameters described herein. Preamble generation component 602 can transmit the random access preamble to initiate the random access procedure. For instance, the random access procedure can be employed for initial access to a system, handover from a source base station to a target base station (e.g., base station 206, . . . ), and so forth. However, the claimed subject matter is not limited to the foregoing.

Preamble generation component 602 can transmit the random access preamble on the uplink to cause UE 210 to initiate connecting with base station 206 (e.g., if UE 210 has data to send, if UE 210 is paged, if UE 210 receives a handover command to transition from a source base station to base station 206 which is a target base station, . . . ). A random access preamble can also be referred to as an access request, an access signature, an access probe, a random access probe, a signature sequence, a RACH signature sequence, etc. The random access preamble can include various types of information and can be sent in various manners. For instance, the random access preamble can be sent via a PRACH; however, the claimed subject matter is not so limited.

Base station 206 can receive the random access preamble and response production component 606 can respond by sending a random access response (e.g., message 2, . . . ) to UE 210. A random access response can also be referred to as an access grant, an access response, etc. The random access response can carry various types of information and can be sent in various manners. For instance, the random access response can provide information related to timing alignment (e g., timing advance/alignment (TA) value, . . . ), an initial uplink grant, assignment of a temporary radio network temporary identifier (RNTI), and so forth. By way of example, the random access response yielded by response production component 606 can include an indication that identifies resources that can be used by UE 210 for a scheduled transmission (e.g., message 3, . . . ). By way of another example, the random access response can be sent over a Physical Downlink Control Channel (PDCCH); yet, the claimed subject matter is not so limited.

UE 210 can receive the random access response sent by response production component 606 of base station 206. The random access response can grant uplink resources to be used by UE 210. Moreover, scheduled transmission component 604 of UE 210 can recognize the uplink resources granted to UE 210 in the random access response. Thereafter, scheduled transmission component 604 can yield a scheduled transmission (e.g., message 3, . . . ) that can be sent from UE 210 to base station 206. For instance, the scheduled transmission can convey an identity associated with UE 210; yet, the claimed subject matter is not limited to the foregoing. The scheduled transmission can be an Uplink Shared Channel (UL-SCH) transmission from UE 210 to base station 206 as part of the random access procedure.

Base station 206 can receive the scheduled transmission sent from UE 210. Contention resolution component 608 can evaluate whether the identity conveyed by the scheduled transmission matches a predetermined identity. By way of example, contention resolution can be deemed successful, as recognized by contention resolution component 608, if random access is initiated by PDCCH order and PDCCH is addressed to an RNTI (e.g., cell-RNTI (C-RNTI), . . . ), or if PDCCH is addressed to the temporary RNTI (e.g., temporary C-RNTI, . . . ) and a contention resolution identity of UE 210 matches an uplink Common Control Channel (CCCH) service data unit (SDU). For example, upon detecting a match, contention resolution component 608 can send a contention resolution message (e.g., message 4, . . . ) to UE 210. The contention resolution message can signify an end to the random access procedure. Thus, UE 210 can receive the contention resolution message and recognize an end of the contention based random access (e.g., contention is resolved, . . . ).

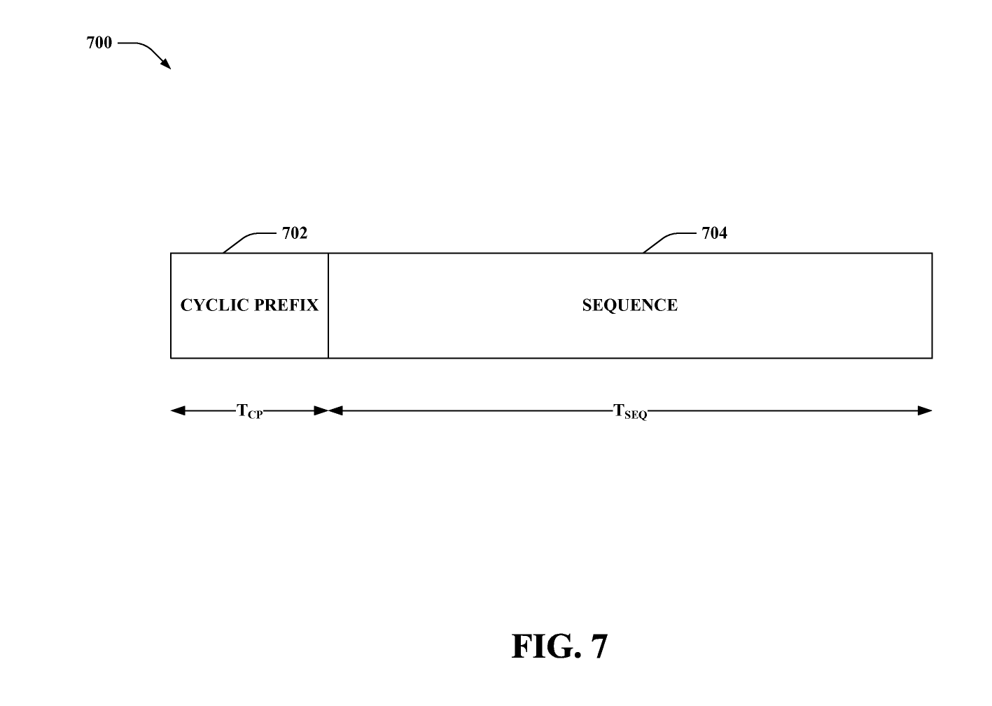

Turning to FIG. 7, illustrated is an example RACH frame structure 700 that can be employed in a wireless communication environment. RACH frame structure 700 includes a cyclic prefix 702 and a sequence 704. PRACH can be the physical channel used to transmit the RACH. Further, cyclic prefix 702 can have a length T_{CP} and sequence 704 can have a length T_{SEQ}. Moreover, a parameter dᵤ, can be defined as the cyclic shift corresponding to Doppler shift (1/T_{SEQ}). It is to be appreciated that RACH frame structure 700 is provided as an example, and the claimed subject matter is not so limited.

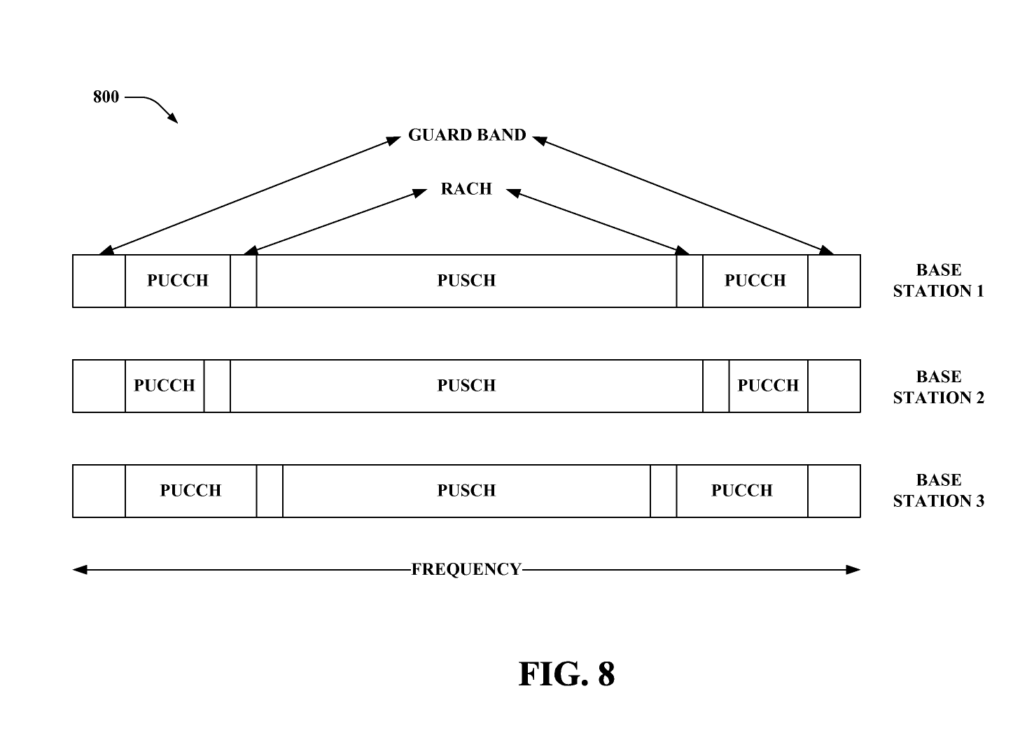

Now referring to FIG. 8, illustrated is an example frequency spectrum 800 according to various aspects. RACH can occupy six resource blocks (RBs). The PRACH in the frequency domain can be located next to the PUCCH at an edge of frequency spectrum 800 as shown. Note that the location of the frequency position may or may not be aligned across base stations. Further, frequency location for RACH can be controlled by a respective base station. As an example, per the depiction in FIG. 8, RACH for base station 1 and base station 2 can cause interference to PUCCH for base station 3—this can cause significant interference to the PUCCH, which can be a source of a problem for network optimization. However, RACH for base station 1 and base station 3 can cause interference to PUSCH for base station 2. Interfering with PUSCH as opposed to PUCCH can be desirable as the PUSCH is less sensitive to varying interference than PUSCH. If aligned with each other, RACHs can interfere with each other. Note that a base station can choose to schedule PUSCH transmissions in the RACH area.

Below are additional examples related to random access. It is to be appreciated, however, that the claimed subject matter is not limited to the below examples.

According to an example, RACH preambles can be generated from Zadoff-Chu (ZC) sequences with a zero correlation zone from one or several root ZC sequences. The network can configure the set of preamble sequences that a UE is allowed to use. There are 64 preamble sequences in a cell with the RACH root sequence (R_{RS}) broadcast as system information. Available cyclic shifts of a root ZC sequence with logical index R_{RS} can be listed in increasing order. If 64 preambles cannot be generated, the next logical root sequence can be used, the order being cyclic, such that the logical index 0 is consecutive to 837.

By way of another example, a maximum of 64 RACH preambles per cell can be allowed. Each of these preambles can be orthogonal to each other, but may not be orthogonal to a neighbor cell. The RACH preambles can be further classified into an unrestricted set for lower Dopplers and restricted set for higher Dopplers (e.g., high speed trains at speeds greater than 300 kph, . . . ). The parameter dᵤ, noted above, can be used in the sequence selection process.

Pursuant to yet another example, for a given N_{CS} value, note that the roots that are reserved for use with a N_{CS} greater than or equal to a particular N_{CS} value can be used. The choice of N_{CS} can be determined by the zone of zero correlation leveraged, which can be calculated by the maximum propagation delay in the cell (e.g., determined by call radius, . . . ).

By way of another example, upper layers can provide a preamble index, a target preamble received power, a corresponding random access—RNTI (RA-RNTI), a PRACH resource, and so forth. The transmission power of a RACH preamble can be given by P_{PRACH}=min {Pₘₐₓ, target preamble received power+downlink pathloss estimate at UE}. In the foregoing, Pₘₐₓ can be the maximum allowed UE power, which can be UE class dependent. The preamble sequence can be selected using the preamble index. A single preamble can be transmitted with the selected preamble sequence and the transmission power, P_{PRACH}, on the indicated PRACH resource. Further, a random backoff can be applied to mitigate collision of RACH attempts from each UE in subsequent attempts.

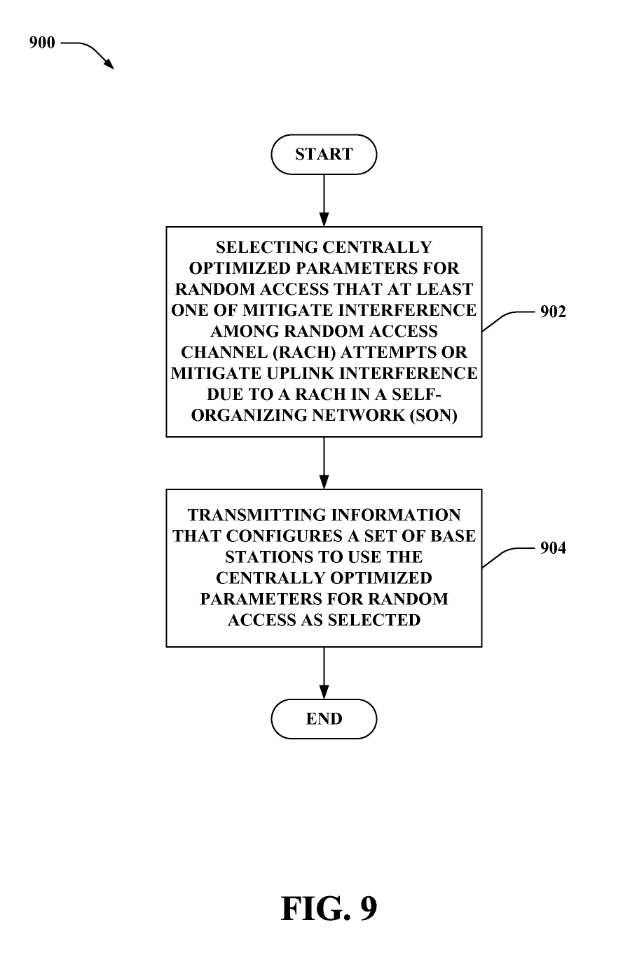

Referring to FIGS. 9-11, methodologies relating to RACH parameter optimization in a SON wireless communication environment are illustrated. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

With reference to FIG. 9, illustrated is a methodology 900 that facilitates centrally optimizing parameters for random access in a wireless communication environment. At 902, centrally optimized parameters for random access that at least one of mitigate interference among Random Access Channel (RACH) attempts or mitigate uplink interference due to a RACH can be selected in a self-organizing network (SON). For instance, the centrally optimized parameters can be selected by a network manager. Further, the centrally optimized parameters for random access can be updated.

The centrally optimized parameters can include physical layer parameters and/or medium access control (MAC) parameters. According to an example where the centrally optimized parameters include physical layer parameters, the physical layer parameters can be Physical Random Access Channel (PRACH) configurations. Following this example, PRACH configuration indices can be optimized across neighboring base stations in a set of base stations to minimize reuse of slots by the neighboring base stations to mitigate RACH collisions when a common frequency resource is used by the neighboring base stations. By way of another example where the centrally optimized parameters include physical layer parameters, the physical layer parameters can be root sequence parameters. For instance, the root sequence parameters can be root sequence indices, cyclic shifts, and/or set types (e.g., unrestricted, restricted, . . . ). Following this example, a subset of the root sequence indices can be allocated for use by cells configured to support high speed user equipments (UEs) (e.g., having a velocity greater than a threshold such as 300 kph, . . . ). Additionally or alternatively, a disparate subset of the root sequence indices can be reserved for use by a base station to measure interference in a RACH region; a message reporting the interference in the RACH region measured by the base station can be received and the centrally optimized parameters can be reselected (e.g., further optimized, . . . ) based upon the message reporting the interference in the RACH region measured by the base station.

In accordance with an example where the centrally optimized parameters include MAC parameters, the MAC parameters can relate to initial transmit power for random access preambles to mitigate overloading femto cell base stations. For instance, a range for the initial transmit power for the random access preambles can be selected, and base stations in the set can respectively configure the initial transmit power for the random access preambles within the range. According to another example, the MAC parameters can include ranges for power ramp step, maximum number of preamble transmissions, contention resolution timer, and so forth; further, base stations in the set can respectively configure the power ramp step, the maximum number of preamble transmissions, the contention resolution timer, and so forth within the corresponding ranges.

At 904, information that configures a set of base stations to use the centrally optimized parameters for random access as selected can be transmitted. For instance, the information can be transmitted over an Itf-N interface to a device manager. According to another example, information related to measured uplink interference due to RACH and/or interference in the RACH region can be received (e.g., via the Itf-N interface, . . . ); further optimization of the centrally optimized parameters can be performed as a function of such received information.

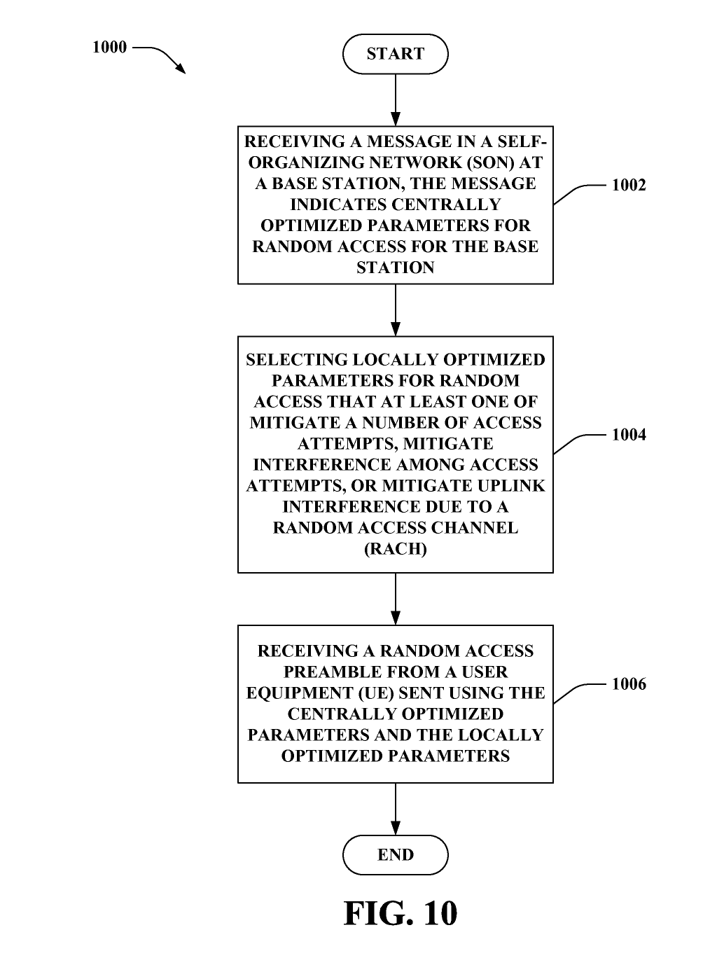

Now turning to FIG. 10, illustrated is a methodology 1000 that facilitates locally optimizing parameters for random access in a wireless communication environment. At 1002, a message can be received in a self-organizing network (SON) at a base station. The message can indicate centrally optimized parameters for random access for the base station. For instance, the centrally optimized parameters can be selected by a network manager. Moreover, the message can be received via an Itf-S interface from a device manager.

At 1004, locally optimized parameters for random access that at least one of mitigate a number of access attempts, mitigate interference among access attempts, or mitigate uplink interference due to a Random Access Channel (RACH) can be selected. The locally optimized parameters for random access can be selected as a function of information received via a Uu interface (e.g., from a user equipment (UE), . . . ), an X2 interface (e.g., from a disparate base station, . . . ), and/or the Itf-S interface (e.g., from the network manager via the device manager, . . . ). For instance, information can be shared between the base station and the disparate base station over the X2 interface, and such information can be used for distributed optimization. At 1006, a random access preamble can be received from a user equipment (UE) sent using the centrally optimized parameters and the locally optimized parameters.

According to an example, the random access preamble received from the UE can include a message that reports a number of access attempts. Following this example, the message can be a radio resource control (RRC) message. Thus, upon successful access, the number of access attempts by the UE can be detected by the base station. Moreover, information specifying the number of access attempts can be transmitted over the X2 interface to the disparate base station. Additionally or alternatively, information specifying a differing number of access attempts detected by the disparate base station can be received over the X2 interface. Further, the locally optimized parameters for random access can be selected as a function of the number of access attempts (e.g., detected by the base station, received via the X2 interface from the disparate base station, . . . ).

By way of a further example, uplink interference due to the RACH can be measured by the base station. Pursuant to this example, the locally optimized parameters for random access can be selected based upon the uplink interference due to the RACH measured by the base station. Moreover, the uplink interference due to the RACH measured by the base station can be reported to a network manager (e.g., sent over the Itf-S interface, . . . ), exchanged with the disparate base station over the X2 interface, and so forth.

Pursuant to another example, interference among access attempts can be measured by the base station. For instance, the centrally optimized parameters can indicate a reserved root sequence index for use by the base station to measure interference in a RACH region. Further, the UE can be instructed by the base station to send a signal using the reserved root sequence index. Moreover, the interference in the RACH region can be measured by the base station based upon the signal received from the UE. Following this example, the locally optimized parameters for random access can be selected based upon the interference in the RACH region measured by the base station. Moreover, the interference in the RACH region measured by the base station can be reported to the network manager (e.g., sent over the Itf-S interface, . . . ), exchanged with the disparate base station over the X2 interface, and so forth.

The locally optimized parameters can include a physical layer parameter and/or a medium access control (MAC) parameter. According to an example where the locally optimized parameters include a physical layer parameter, the physical layer parameter can be a sequence length, N_{CS}. The sequence length can be selected based upon an expected round trip delay. Yet, the claimed subject matter is not limited to the foregoing example.

Pursuant to another example where the locally optimized parameters include a MAC parameter, the MAC parameter can be an initial received target power of the random access preamble, a power ramp step, a contention resolution timer, a maximum number of preamble transmissions, and the like. For instance, the centrally optimized parameters can specify respective ranges for one or more of the MAC parameters. Thus, the one or more MAC parameters can be selected within the respective ranges. The MAC parameters can be controlled to allow for the random access preamble to be sent by the UE with sufficient power to be detected by the base station, to mitigate access delay, while managing interference caused on the uplink.

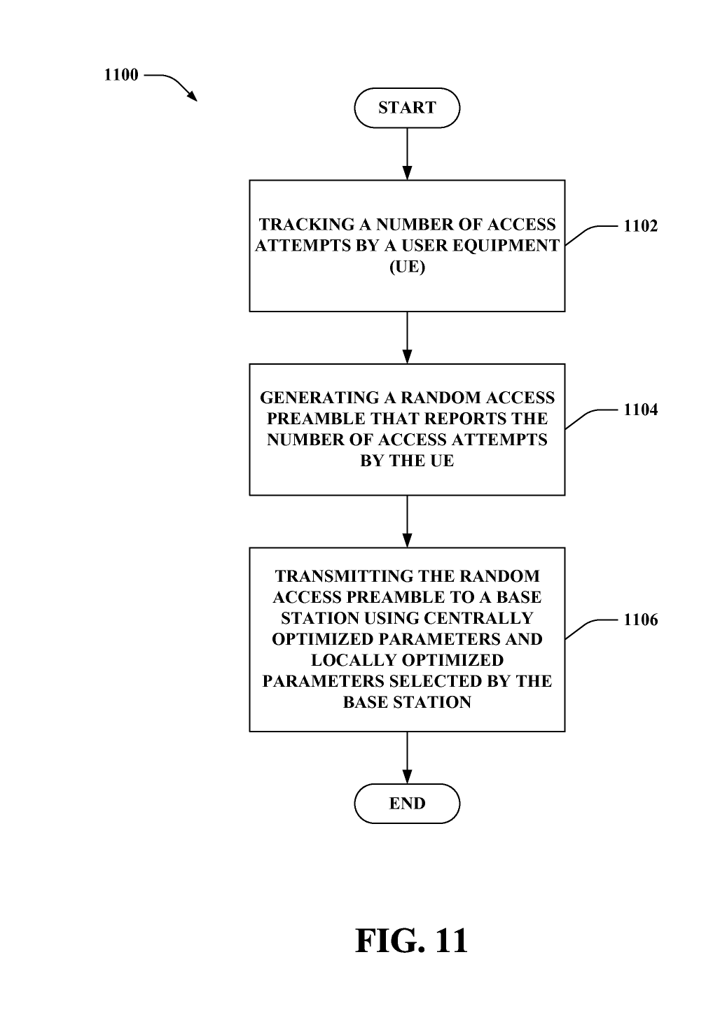

Referring to FIG. 11, illustrated is a methodology 1100 that facilitates indicating a number of access attempts in a wireless communication environment. At 1102, a number of access attempts by a user equipment (UE) can be tracked. At 1104, a random access preamble that reports the number of access attempts can be generated by the UE. For example, the number of access attempts can be included in a radio resource control (RRC) message. At 1106, the random access preamble can be transmitted to a base station using centrally optimized parameters and locally optimized parameters selected by the base station.

According to another example, the number of access attempts can be reported to a self-organizing network (SON) server. Following this example, information indicating transmit powers for random access preambles can be reported with the number of access attempts to the SON server.

It will be appreciated that, in accordance with one or more aspects described herein, inferences can be made pertaining to optimizing RACH parameters in a SON wireless communication environment. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

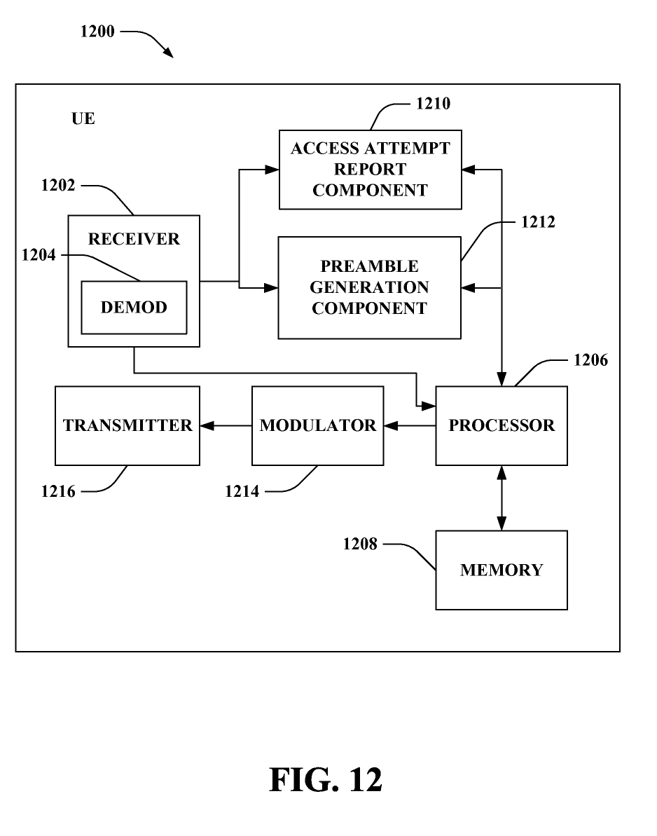

FIG. 12 is an illustration of a UE 1200 that yields random access preambles in a wireless communication system. UE 1200 comprises a receiver 1202 that receives a signal from, for instance, a receive antenna (not shown), and performs typical actions thereon (e.g., filters, amplifies, downconverts, etc.) the received signal and digitizes the conditioned signal to obtain samples. Receiver 1202 can be, for example, an MMSE receiver, and can comprise a demodulator 1204 that can demodulate received symbols and provide them to a processor 1206 for channel estimation. Processor 1206 can be a processor dedicated to analyzing information received by receiver 1202 and/or generating information for transmission by a transmitter 1216, a processor that controls one or more components of UE 1200, and/or a processor that both analyzes information received by receiver 1202, generates information for transmission by transmitter 1216, and controls one or more components of UE 1200.

UE 1200 can additionally comprise memory 1208 that is operatively coupled to processor 1206 and that can store data to be transmitted, received data, and any other suitable information related to performing the various actions and functions set forth herein. Memory 1208, for instance, can store protocols and/or algorithms associated with tracking a number of access attempts, generating a random access preamble that reports the number of random access attempts, and the like.

It will be appreciated that the data store (e.g., memory 1208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1208 of the subject systems and methods is intended to comprise, without being limited to, these and any other suitable types of memory.

Processor 1206 can be operatively coupled to an access attempt report component 1210 and/or a preamble generation component 1212. Access attempt report component 1210 can be substantially similar to access attempt report component 224 of FIG. 2 and/or preamble generation component 1212 can be substantially similar to preamble generation component 602 of FIG. 6. Access attempt report component 1210 can track a number of access attempts effectuated by UE 1200. Further, access attempt report component 1210 can include a message that specifies the number of access attempts in a random access preamble yielded by preamble generation component 1212. Moreover, access attempt report component 1210 can report the number of access attempts (e.g., successful and unsuccessful, . . . ) along with transmit power information to a SON server, for example. Although not shown, it is contemplated that UE 1200 can further include a scheduled transmission component, which can be substantially similar to scheduled transmission component 604 of FIG. 6. UE 1200 still further comprises a modulator 1214 and a transmitter 1216 that transmits data, signals, etc. to a base station. Although depicted as being separate from the processor 1206, it is to be appreciated that access attempt report component 1210, preamble generation component 1212, and/or modulator 1214 can be part of processor 1206 or a number of processors (not shown).

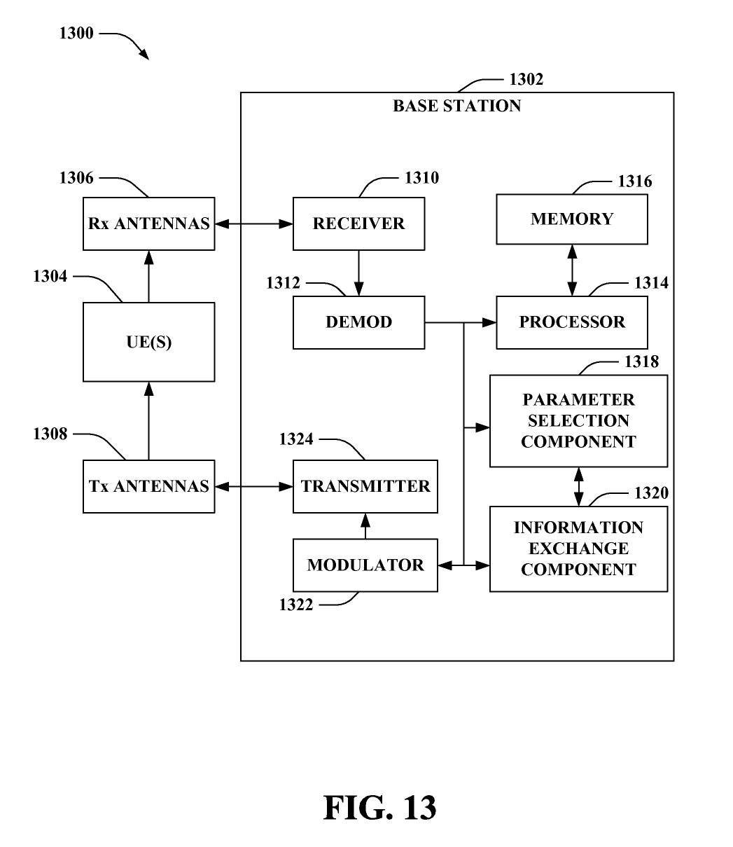

FIG. 13 is an illustration of a system 1300 that locally optimizes parameters for random access in a wireless communication environment. System 1300 comprises a base station 1302 (e.g., access point, . . . ) with a receiver 1310 that receives signal(s) from one or more UEs 1304 through a plurality of receive antennas 1306, and a transmitter 1324 that transmits to the one or more UEs 1304 through a plurality of transmit antennas 1308. Receiver 1310 can receive information from receive antennas 1306 and is operatively associated with a demodulator 1312 that demodulates received information. Demodulated symbols are analyzed by a processor 1314 that can be similar to the processor described above with regard to FIG. 12, and which is coupled to a memory 1316 that stores data to be transmitted to or received from UE(s) 1304 and/or any other suitable information related to performing the various actions and functions set forth herein. Processor 1314 is further coupled to a parameter selection component 1318 and/or an information exchange component 1320. Parameter selection component 1318 can be substantially similar to parameter selection component 220 of FIG. 2 and/or information exchange component 1320 can be substantially similar to information exchange component 222 of FIG. 2. Information exchange component 1320 can receive a message that indicates centrally optimized parameters for random access for base station 1302. Moreover, parameter selection component 1318 can select locally optimized parameters for random access that mitigate a number of access attempts, mitigate interference among access attempts, and/or mitigate uplink interference due to RACH. Further, information exchange component 1320 can exchange information over various interfaces as set forth herein. Although not shown, it is contemplated that base station 1302 can further include an access attempt detection component (e.g., substantially similar to access attempt detection component 216 of FIG. 2, . . . ), an interference monitor component (e.g., substantially similar to interference monitor component 218 of FIG. 2, . . . ), a response production component (e.g., substantially similar to response production component 606 of FIG. 6, . . . ), and/or a contention resolution component (e.g., substantially similar to contention resolution component 608 of FIG. 6, . . . ). Base station 1302 can further include a modulator 1322. Modulator 1322 can multiplex a frame for transmission by a transmitter 1324 through antennas 1308 to UE(s) 1304 in accordance with the aforementioned description. Although depicted as being separate from the processor 1314, it is to be appreciated that parameter selection component 1318, information exchange component 1320, and/or modulator 1322 can be part of processor 1314 or a number of processors (not shown).

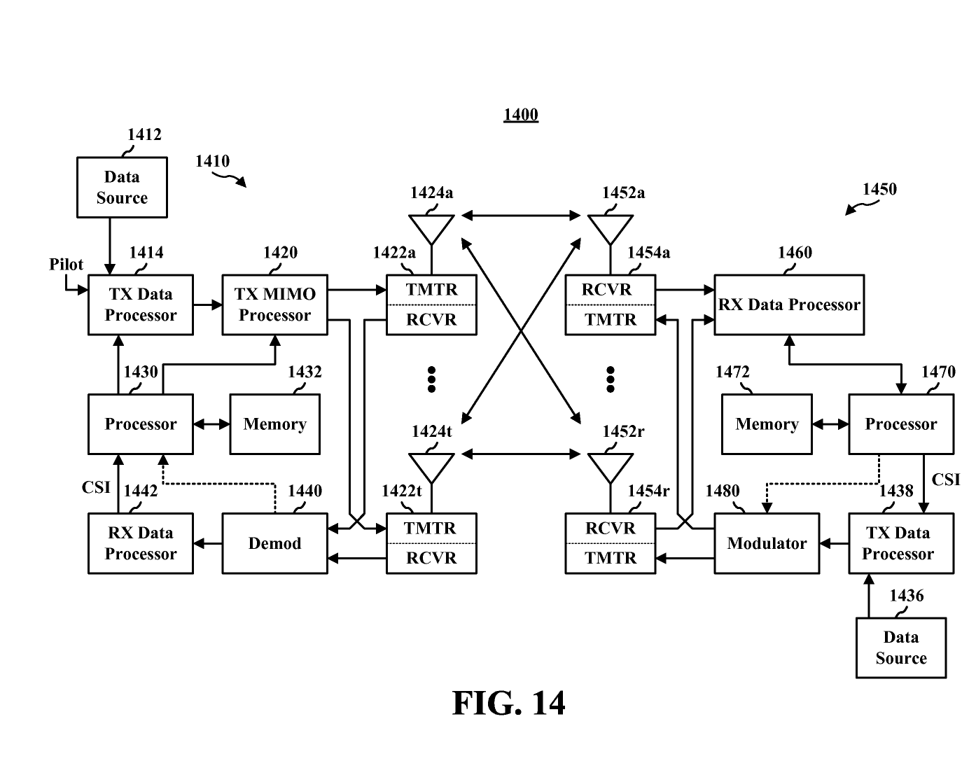

FIG. 14 shows an example wireless communication system 1400. The wireless communication system 1400 depicts one base station 1410 and one UE 1450 for sake of brevity. However, it is to be appreciated that system 1400 can include more than one base station and/or more than one UE, wherein additional base stations and/or UEs can be substantially similar or different from example base station 1410 and UE 1450 described below. In addition, it is to be appreciated that base station 1410 and/or UE 1450 can employ the systems (FIGS. 1-2, 4, 6, 12-13, and 15-17) and/or methods (FIGS. 9-11) described herein to facilitate wireless communication there between.

At base station 1410, traffic data for a number of data streams is provided from a data source 1412 to a transmit (TX) data processor 1414. According to an example, each data stream can be transmitted over a respective antenna. TX data processor 1414 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at UE 1450 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1430.

The modulation symbols for the data streams can be provided to a TX MIMO processor 1420, which can further process the modulation symbols (e.g., for OFDM). TX MIMO processor 1420 then provides N_{T} modulation symbol streams to N_{T} transmitters (TMTR) 1422a through 1422t. In various embodiments, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1422a through 1422t are transmitted from N_{T} antennas 1424a through 1424t, respectively.

At UE 1450, the transmitted modulated signals are received by N_{R} antennas 1452a through 1452r and the received signal from each antenna 1452 is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 can receive and process the N_{R} received symbol streams from N_{R} receivers 1454 based on a particular receiver processing technique to provide N_{T} “detected” symbol streams. RX data processor 1460 can demodulate, deinterleave, and decode each detected symbol stream to recover the traffic data for the data stream. The processing by RX data processor 1460 is complementary to that performed by TX MIMO processor 1420 and TX data processor 1414 at base station 1410.

A processor 1470 can periodically determine which available technology to utilize as discussed above. Further, processor 1470 can formulate a reverse link message comprising a matrix index portion and a rank value portion.

The reverse link message can comprise various types of information regarding the communication link and/or the received data stream. The reverse link message can be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from UE 1450 are received by antennas 1424, conditioned by receivers 1422, demodulated by a demodulator 1440, and processed by a RX data processor 1442 to extract the reverse link message transmitted by UE 1450. Further, processor 1430 can process the extracted message to determine which precoding matrix to use for determining the beamforming weights.

Processors 1430 and 1470 can direct (e.g., control, coordinate, manage, etc.) operation at base station 1410 and UE 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

It is to be understood that the embodiments described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

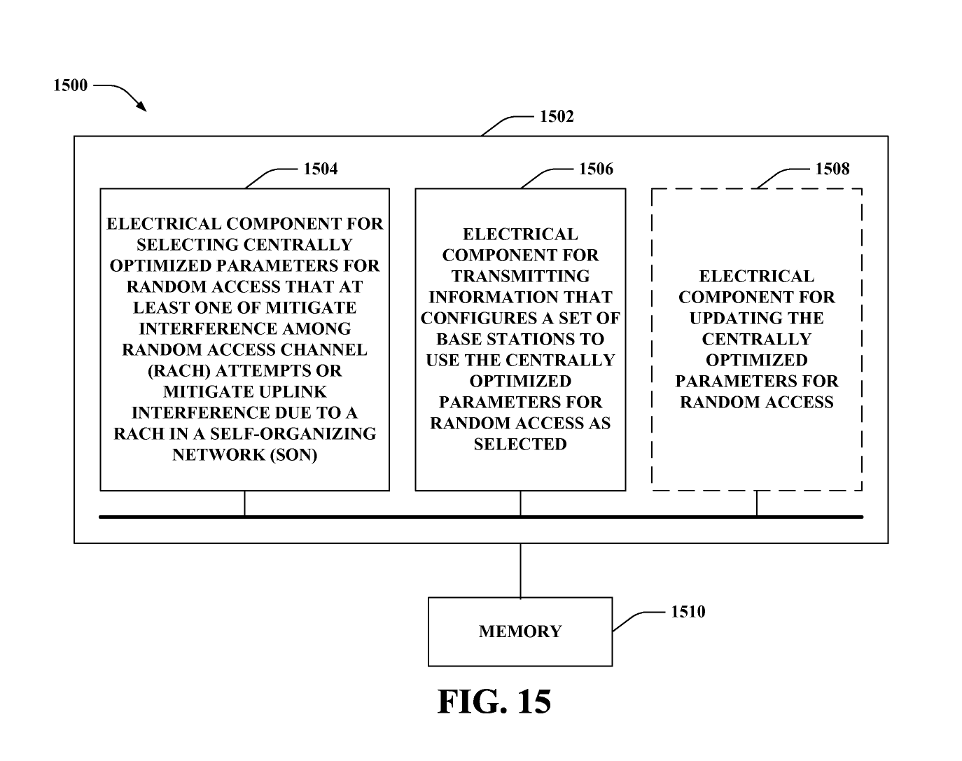

With reference to FIG. 15, illustrated is a system 1500 that enables centrally optimizing parameters for random access in a wireless communication environment. For example, system 1500 can reside at least partially within a network manager. It is to be appreciated that system 1500 is represented as including functional blocks, which can be functional blocks that represent functions implemented by a processor, software, or combination thereof (e.g., firmware). System 1500 includes a logical grouping 1502 of electrical components that can act in conjunction. For instance, logical grouping 1502 can include an electrical component for selecting centrally optimized parameters for random access that at least one of mitigate interference among Random Access Channel (RACH) attempts or mitigate uplink interference due to RACH in a self-organizing network (SON) 1504. Moreover, logical grouping 1502 can include an electrical component for transmitting information that configures a set of base stations to use the centrally optimized parameters for random access as selected 1506. Logical grouping 1502 can also optionally include an electrical component for updating the centrally optimized parameters for random access 1508. Additionally, system 1500 can include a memory 1510 that retains instructions for executing functions associated with electrical components 1504, 1506, and 1508. While shown as being external to memory 1510, it is to be understood that one or more of electrical components 1504, 1506, and 1508 can exist within memory 1510.

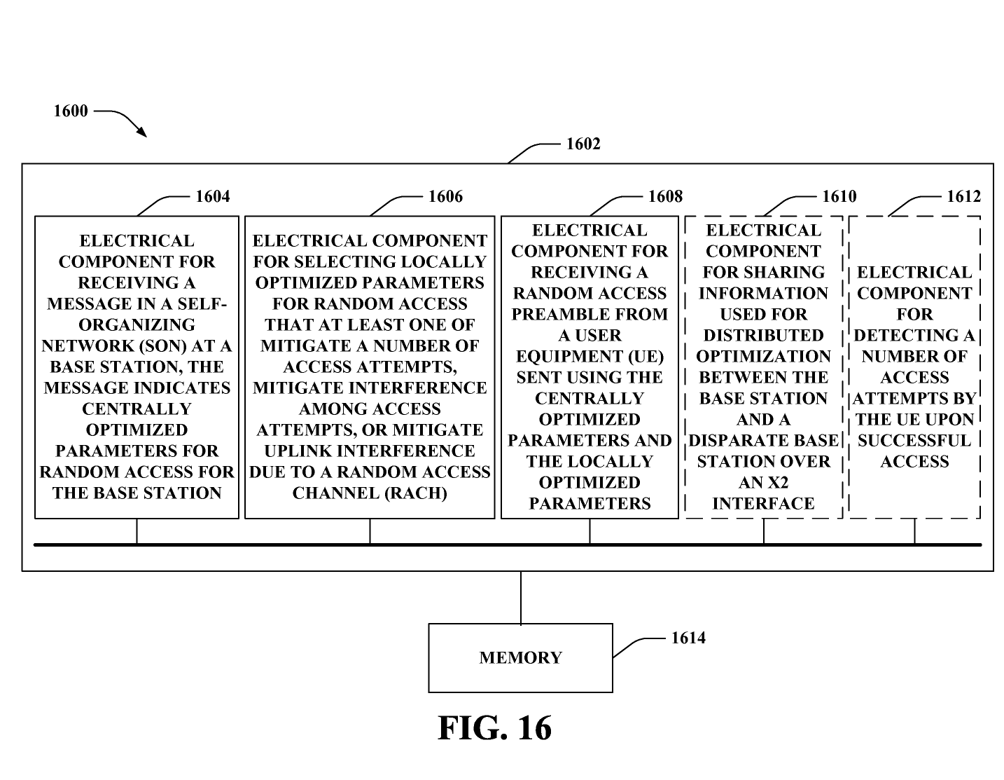

With reference to FIG. 16, illustrated is a system 1600 that enables effectuating local optimization of parameters for random access in a wireless communication environment. For example, system 1600 can reside at least partially within a base station. It is to be appreciated that system 1600 is represented as including functional blocks, which can be functional blocks that represent functions implemented by a processor, software, or combination thereof (e.g., firmware). System 1600 includes a logical grouping 1602 of electrical components that can act in conjunction. For instance, logical grouping 1602 can include an electrical component for receiving a message in a self-organizing network (SON) at a base station 1604. For instance, the message can indicate centrally optimized parameters for random access for the base station. Further, logical grouping 1602 can include an electrical component for selecting locally optimized parameters for random access that at least one of mitigate a number of access attempts, mitigate interference among access attempts, or mitigate uplink interference due to a Random Access Channel (RACH) 1606. Moreover, logical grouping 1602 can include an electrical component for receiving a random access preamble from a user equipment (UE) sent using the centrally optimized parameters and the locally optimized parameters 1608. Logical grouping 1602 can also optionally include an electrical component for sharing information used for distributed optimization between the base station and a disparate base station over an X2 interface 1610. Further, logical grouping 1602 can optionally include an electrical component for detecting a number of access attempts by the UE upon successful access 1612. Additionally, system 1600 can include a memory 1614 that retains instructions for executing functions associated with electrical components 1604, 1606, 1608, 1610, and 1612. While shown as being external to memory 1614, it is to be understood that one or more of electrical components 1604, 1606, 1608, 1610, and 1612 can exist within memory 1614.

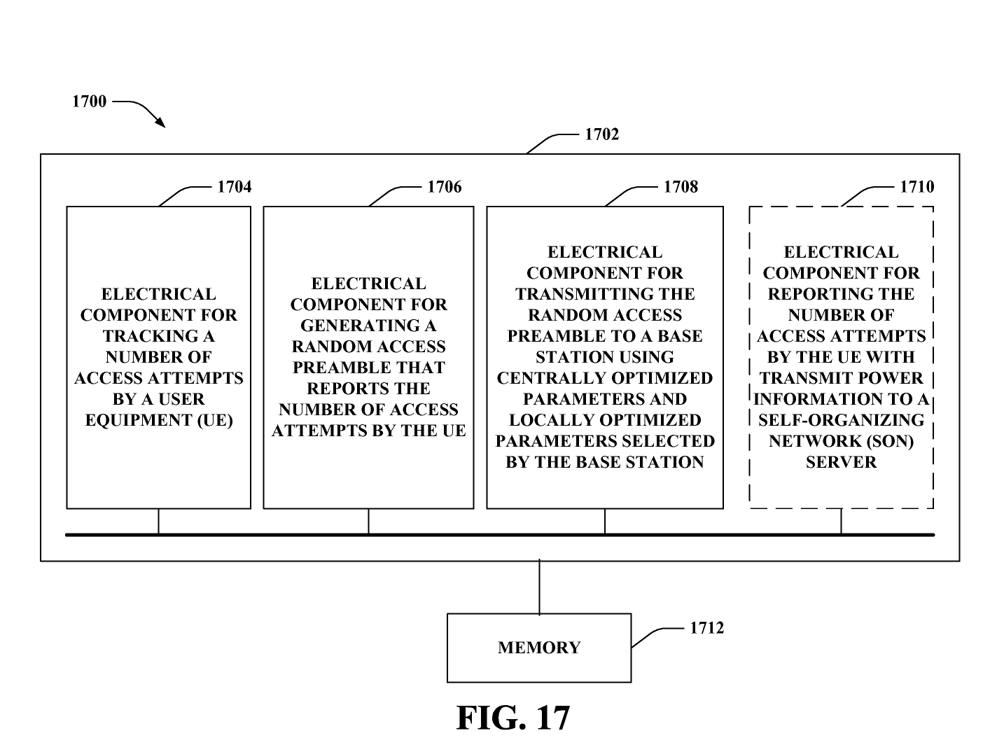

With reference to FIG. 17, illustrated is a system 1700 that enables accessing a base station in a wireless communication environment. For example, system 1700 can reside within a UE. It is to be appreciated that system 1700 is represented as including functional blocks, which can be functional blocks that represent functions implemented by a processor, software, or combination thereof (e.g., firmware). System 1700 includes a logical grouping 1702 of electrical components that can act in conjunction. For instance, logical grouping 1702 can include an electrical component for tracking a number of access attempts by a user equipment (UE) 1704. Further, logical grouping 1702 can include an electrical component for generating a random access preamble that reports the number of access attempts by the UE 1706. Moreover, logical grouping 1702 can include an electrical component for transmitting the random access preamble to a base station using centrally optimized parameters and locally optimized parameters selected by the base station 1708. Logical grouping 1702 can also optionally include an electrical component for reporting the number of access attempts by the UE with transmit power information to a self-organizing network (SON) server 1710. Additionally, system 1700 can include a memory 1712 that retains instructions for executing functions associated with electrical components 1704, 1706, 1708, and 1710. While shown as being external to memory 1712, it is to be understood that one or more of electrical components 1704, 1706, 1708, and 1710 can exist within memory 1712.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates centrally optimizing parameters for random access in a wireless communication environment, comprising:
selecting centrally optimized parameters for random access that at least one of mitigate interference among Random Access Channel (RACH) attempts or mitigate uplink interference due to a RACH in a self-organizing network (SON); and
transmitting information that configures a set of base stations to use the centrally optimized parameters for random access as selected.

2. The method of claim 1, wherein the centrally optimized parameters are selected by a network manager.

3. The method of claim 1, further comprising updating the centrally optimized parameters for random access.

4. The method of claim 1, wherein the centrally optimized parameters include physical layer parameters.

5. The method of claim 4, wherein the physical layer parameters include Physical Random Access Channel (PRACH) configurations.

6. The method of claim 5, further comprising optimizing PRACH configuration indices across neighboring base stations in the set of base stations to minimize reuse of slots by the neighboring base stations to mitigate RACH collisions when a common frequency resource is used by the neighboring base stations.

7. The method of claim 4, wherein the physical layer parameters include root sequence parameters including one or more of root sequence indices, cyclic shifts and set types.

8. The method of claim 7, further comprising allocating a particular subset of the root sequence indices for use by cells configured to support high speed user equipments (UEs).

9. The method of claim 7, further comprising reserving a given subset of the root sequence indices for use by the set of base stations to measure interference in a RACH region.

10. The method of claim 9, further comprising:
receiving a message reporting the interference in the RACH region measured by a particular base station in the set of base stations; and
reselecting the centrally optimized parameters for random access based upon the message reporting the interference in the RACH region measured by the particular base station.

11. The method of claim 1, wherein the centrally optimized parameters include medium access control (MAC) parameters that relate to initial transmit power for random access preambles to mitigate overloading femto cell base stations.

12. The method of claim 11, further comprising selecting a range for the initial transmit power for the random access preambles, wherein base stations in the set of base stations respectively configure the initial transmit power for the random access preambles within the range.

13. The method of claim 11, wherein the MAC parameters include ranges for one or more of an initial transmit power, a power ramp step, a maximum number of preamble transmissions, or a contention resolution timer.

14. The method of claim 1, further comprising:
receiving information related to one or more of a measured uplink interference due to the RACH or a measured interference in a RACH region; and
selecting the centrally optimized parameters for random access based upon the information.

15. A wireless communications apparatus, comprising:
a memory that retains instructions related to selecting centrally optimized parameters for random access that at least one of mitigate interference among Random Access Channel (RACH) attempts or mitigate uplink interference due to a RACH in a self-organizing network (SON), and transmitting information that configures a set of base stations to use the centrally optimized parameters for random access as selected; and
a processor, coupled to the memory, configured to execute the instructions retained in the memory.

16. The wireless communication apparatus of claim 15, wherein the memory further retains instructions related to updating the centrally optimized parameters for random access.

17. The wireless communication apparatus of claim 15, wherein the centrally optimized parameters include Physical Random Access Channel (PRACH) configurations.

18. The wireless communication apparatus of claim 17, wherein the memory further retains instructions related to optimizing PRACH configuration indices across neighboring base stations in the set of base stations to minimize reuse of slots by the neighboring base stations to mitigate RACH collisions when a common frequency resource is used by the neighboring base stations.

19. The wireless communication apparatus of claim 15, wherein the centrally optimized parameters include root sequence parameters including one or more of root sequence indices, cyclic shifts and set types.

20. The wireless communication apparatus of claim 19, wherein the memory further retains instructions related to at least one of allocating a first subset of the root sequence indices for use by cells configured to support high speed user equipments (UEs), or reserving a given subset of the root sequence indices for use by the set of base stations to measure interference in a RACH region.

21. The wireless communication apparatus of claim 20, wherein the memory further retains instructions related to receiving a message reporting the interference in the RACH region measured by a particular base station in the set of base stations, and reselecting the centrally optimized parameters for random access based upon the message reporting the interference in the RACH region measured by the particular base station.

22. The wireless communication apparatus of claim 15, wherein the centrally optimized parameters include medium access control (MAC) parameters, the MAC parameters include ranges for one or more of an initial transmit power, a power ramp step, a maximum number of preamble transmissions, or a contention resolution timer.

23. The wireless communication apparatus of claim 15, wherein the memory further retains instructions related to receiving information related to one or more of a measured uplink interference due to the RACH or a measured interference in a RACH region, and selecting the centrally optimized parameters for random access based upon the information.

24. A wireless communications apparatus that enables centrally optimizing parameters for random access in a wireless communication environment, comprising:
means for selecting centrally optimized parameters for random access that at least one of mitigate interference among Random Access Channel (RACH) attempts or mitigate uplink interference due to RACH in a self-organizing network (SON); and
means for transmitting information that configures a set of base stations to use the centrally optimized parameters for random access as selected.

25. The wireless communications apparatus of claim 24, further comprising means for updating the centrally optimized parameters for random access.

26. The wireless communications apparatus of claim 24, wherein the centrally optimized parameters include Physical Random Access Channel (PRACH) configurations.

27. The wireless communications apparatus of claim 24, wherein the centrally optimized parameters include root sequence parameters including one or more of root sequence indices, cyclic shifts and set types.

28. The wireless communications apparatus of claim 24, wherein the centrally optimized parameters include medium access control (MAC) parameters, the MAC parameters include ranges for one or more of an initial transmit power, a power ramp step, a maximum number of preamble transmissions, or a contention resolution timer.

29. A computer program product, comprising:
a computer-readable medium comprising:
code for selecting centrally optimized parameters for random access that at least one of mitigate interference among Random Access Channel (RACH) attempts or mitigate uplink interference due to RACH in a self-organizing network (SON); and
code for transmitting information that configures a set of base stations to use the centrally optimized parameters for random access as selected.

30. The computer program product of claim 29, wherein the computer-readable medium further comprises code for updating the centrally optimized parameters for random access.

31. The computer program product of claim 29, wherein the centrally optimized parameters include Physical Random Access Channel (PRACH) configurations.

32. The computer program product of claim 29, wherein the centrally optimized parameters include root sequence parameters including one or more of root sequence indices, cyclic shifts and set types.

33. The computer program product of claim 29, wherein the centrally optimized parameters include medium access control (MAC) parameters, the MAC parameters include ranges for one or more of an initial transmit power, a power ramp step, a maximum number of preamble transmissions, or a contention resolution timer.

34. A wireless communications apparatus, comprising:
a processor configured to:
select centrally optimized parameters for random access that at least one of mitigate interference among Random Access Channel (RACH) attempts or mitigate uplink interference due to a RACH in a self-organizing network (SON); and
transmit information that configures a set of base stations to use the centrally optimized parameters for random access as selected.

35. A method that facilitates locally optimizing parameters for random access in a wireless communication environment, comprising:
receiving a message in a self-organizing network (SON) at a base station, the message indicates centrally optimized parameters for random access for the base station;
selecting locally optimized parameters for random access that at least one of mitigate a number of access attempts, mitigate interference among access attempts, or mitigate uplink interference due to a Random Access Channel (RACH); and
receiving a random access preamble from a user equipment (UE) sent using the centrally optimized parameters and the locally optimized parameters.

36. The method of claim 35, further comprising sharing information between the base station and a disparate base station over an X2 interface for distributed optimization.

37. The method of claim 35, wherein the random access preamble received from the UE includes a message that reports a number of access attempts.

38. The method of claim 37, wherein the message is a radio resource control (RRC) message.

39. The method of claim 37, further comprising detecting the number of access attempts by the UE upon successful access.

40. The method of claim 37, further comprising selecting the locally optimized parameters for random access as a function of the number of access attempts.

41. The method of claim 37, further comprising exchanging information specifying the number of access attempts with a disparate base station via an X2 interface.

42. The method of claim 35, further comprising:
measuring uplink interference due to the RACH at the base station; and
selecting the locally optimized parameters for random access based upon the uplink interference due to the RACH as measured.

43. The method of claim 35, further comprising:
measuring interference among access attempts at the base station; and
selecting the locally optimized parameters for random access based upon the interference among access attempts as measured.

44. The method of claim 43, further comprising:
instructing the UE to send a signal using a reserved root sequence index, the reserved root sequence index provided as part of the centrally optimized parameters;
measuring interference in a RACH region based upon the signal received from the UE; and
selecting the locally optimized parameters for random access based upon the interference in the RACH region.

45. The method of claim 35, wherein the locally optimized parameters include a sequence length selected based upon an expected round trip delay.

46. The method of claim 35, wherein the locally optimized parameters include one or more medium access control (MAC) parameters, the one or more MAC parameters being at least one of an initial received target power of the random access preamble, a power ramp step, a contention resolution timer, or a maximum number of preamble transmissions.

47. The method of claim 46, wherein the centrally optimized parameters specify respective ranges for the one or more MAC parameters.

48. A wireless communications apparatus, comprising:
a memory that retains instructions related to receiving a message in a self-organizing network (SON) at a base station, the message indicates centrally optimized parameters for random access for the base station, selecting locally optimized parameters for random access that at least one of mitigate a number of access attempts, mitigate interference among access attempts, or mitigate uplink interference due to a Random Access Channel (RACH), and receiving a random access preamble from a user equipment (UE) sent using the centrally optimized parameters and the locally optimized parameters; and
a processor, coupled to the memory, configured to execute the instructions retained in the memory.

49. The wireless communications apparatus of claim 48, wherein the memory further retains instructions related to sharing information between the base station and a disparate base station over an X2 interface for distributed optimization.

50. The wireless communications apparatus of claim 48, wherein the memory further retains instructions related to detecting a number of access attempts by the UE upon successful access.

51. The wireless communications apparatus of claim 50, wherein the memory further retains instructions related to at least one of selecting the locally optimized parameters for random access as a function of the number of access attempts, or exchanging information specifying the number of access attempts with a disparate base station via an X2 interface.

52. The wireless communications apparatus of claim 48, wherein the memory further retains instructions related to measuring at least one of interference due to the RACH or interference among access attempts.

53. The wireless communications apparatus of claim 48, wherein the memory further retains instructions related to instructing the UE to send a signal using a reserved root sequence index, the reserved root sequence index provided as part of the centrally optimized parameters, measuring interference in a RACH region based upon the signal received from the UE, and selecting the locally optimized parameters for random access based upon the interference in the RACH region.

54. The wireless communications apparatus of claim 48, wherein the locally optimized parameters include a sequence length selected based upon an expected round trip delay.

55. The wireless communications apparatus of claim 48, wherein the locally optimized parameters include one or more medium access control (MAC) parameters, the one or more MAC parameters being at least one of an initial received target power of the random access preamble, a power ramp step, a contention resolution timer, or a maximum number of preamble transmissions.

56. The wireless communications apparatus of claim 55, wherein the centrally optimized parameters specify respective ranges for the one or more MAC parameters.

57. A wireless communications apparatus that enables effectuating local optimization of parameters for random access in a wireless communication environment, comprising:
means for receiving a message in a self-organizing network (SON) at a base station, the message indicates centrally optimized parameters for random access for the base station;
means for selecting locally optimized parameters for random access that at least one of mitigate a number of access attempts, mitigate interference among access attempts, or mitigate uplink interference due to a Random Access Channel (RACH); and
means for receiving a random access preamble from a user equipment (UE) sent using the centrally optimized parameters and the locally optimized parameters.

58. The wireless communications apparatus of claim 57, further comprising means for sharing information used for distributed optimization between the base station and a disparate base station over an X2 interface.

59. The wireless communications apparatus of claim 57, further comprising means for detecting a number of access attempts by the UE upon successful access.

60. The wireless communications apparatus of claim 57, wherein the locally optimized parameters include a sequence length selected based upon an expected round trip delay.

61. The wireless communications apparatus of claim 57, wherein the locally optimized parameters include one or more medium access control (MAC) parameters, the one or more MAC parameters being at least one of an initial received target power of the random access preamble, a power ramp step, a contention resolution timer, or a maximum number of preamble transmissions.

62. The wireless communications apparatus of claim 61, wherein the centrally optimized parameters specify respective ranges for the one or more MAC parameters.

63. A computer program product, comprising:
a computer-readable medium comprising:
code for receiving a message in a self-organizing network (SON) at a base station, the message indicates centrally optimized parameters for random access for the base station;
code for selecting locally optimized parameters for random access that at least one of mitigate a number of access attempts, mitigate interference among access attempts, or mitigate uplink interference due to a Random Access Channel (RACH); and
code for receiving a random access preamble from a user equipment (UE) sent using the centrally optimized parameters and the locally optimized parameters.

64. The computer program product of claim 63, wherein the computer-readable medium further comprises code for sharing information used for distributed optimization between the base station and a disparate base station over an X2 interface.

65. The computer program product of claim 63, wherein the computer-readable medium further comprises code for detecting a number of access attempts by the UE upon successful access.

66. The computer program product of claim 63, wherein the locally optimized parameters include a sequence length selected based upon an expected round trip delay.

67. The computer program product of claim 63, wherein the centrally optimized parameters specify respective ranges for the one or more MAC parameters, and the locally optimized parameters include one or more medium access control (MAC) parameters, the one or more MAC parameters being at least one of an initial received target power of the random access preamble, a power ramp step, a contention resolution timer, or a maximum number of preamble transmissions.

68. A wireless communications apparatus, comprising:
a processor configured to:
receive a message in a self-organizing network (SON) at a base station, the message indicates centrally optimized parameters for random access for the base station;
select locally optimized parameters for random access that at least one of mitigate a number of access attempts, mitigate interference among access attempts, or mitigate uplink interference due to a Random Access Channel (RACH); and
receive a random access preamble from a user equipment (UE) sent using the centrally optimized parameters and the locally optimized parameters.

69. A method that facilitates indicating access delay in a wireless communication environment, comprising:
tracking a number of access attempts by a user equipment (UE);
generating a random access preamble that reports the number of access attempts by the UE; and
transmitting the random access preamble to a base station using centrally optimized parameters and locally optimized parameters selected by the base station.

70. The method of claim 69, wherein the number of access attempts is included in a radio resource control (RRC) message.

71. The method of claim 69, further comprising reporting the number of access attempts by the UE with transmit power information to a self-organizing network (SON) server.

72. A wireless communications apparatus, comprising:
a memory that retains instructions related to tracking a number of access attempts by a user equipment (UE), generating a random access preamble that reports the number of access attempts by the UE, and transmitting the random access preamble to a base station using centrally optimized parameters and locally optimized parameters selected by the base station; and
a processor, coupled to the memory, configured to execute the instructions retained in the memory.

73. The wireless communications apparatus of claim 72, wherein the number of access attempts is included in a radio resource control (RRC) message.

74. The wireless communications apparatus of claim 72, wherein the memory further retains instructions related to reporting the number of access attempts by the UE with transmit power information to a self-organizing network (SON) server.

75. A wireless communications apparatus that enables accessing a base station in a wireless communication environment, comprising:
means for tracking a number of access attempts by a user equipment (UE);
means for generating a random access preamble that reports the number of access attempts by the UE; and
means for transmitting the random access preamble to a base station using centrally optimized parameters and locally optimized parameters selected by the base station.

76. The wireless communications apparatus of claim 75, further comprising means for reporting the number of access attempts by the UE with transmit power information to a self-organizing network (SON) server.

77. A computer program product, comprising:
a computer-readable medium comprising:
code for tracking a number of access attempts by a user equipment (UE);
code for generating a random access preamble that reports the number of access attempts by the UE; and
code for transmitting the random access preamble to a base station using centrally optimized parameters and locally optimized parameters selected by the base station.

78. The computer program product of claim 77, wherein the computer-readable medium further comprises code for reporting the number of access attempts by the UE with transmit power information to a self-organizing network (SON) server.

79. A wireless communications apparatus, comprising:
a processor configured to:
track a number of access attempts by a user equipment (UE);
generate a random access preamble that reports the number of access attempts by the UE; and
transmit the random access preamble to a base station using centrally optimized parameters and locally optimized parameters selected by the base station.
